(19) United States
(12) Patent Application Publication
(10) Pub. No.: US 2018/0201289 A1
(43) Pub. Date: Jul. 19, 2018

(54) CART DEVICE

(71) Applicant: OKAMURA CORPORATION, Yokohama-shi, Kanagawa (JP)

(72) Inventors: Yoshihiro SAKAKIBARA, Yokohama-shi, Kanagawa (JP); Nobutada TAKAHASHI, Yokohama-shi, Kanagawa (JP)

(21) Appl. No.: 15/740,045

(22) PCT Filed: Jun. 28, 2016
(86) PCT No.: PCT/JP2016/069129

§ 371 Date: Dec. 27, 2017

(30) Foreign Application Priority Data
Jul. 3, 2015 (JP) 2015-134701

(51) Int. Cl. B62B 3/02; F16M 11/42; B62B 3/00

(52) U.S. Cl. CPC B62B 3/02; A47B 96/061; B62B 3/005; F16M 11/42

(57) ABSTRACT

A cart device (1) includes a first base portion (3a) which can travel on a floor surface, a support body (3b) which extends upward from the first base portion (3a), article placing members (2, 10) on which an article can be placed, and support means (4, 11) for disposing the article placing members (2, 10) on at least three sides around the support body (3b) such that a vertical position of each of the article placing members (2, 10) can be changed.

### TECHNICAL FIELD

The present invention relates to a cart device.

Priority is claimed on Japanese Patent Application No. 2015-134701, filed on Jul. 3, 2015, the content of which is incorporated herein by reference.

### BACKGROUND ART

In general, in public facilities such as offices and hospitals, a fixture provided with a work top plate is installed in order to efficiently perform works such as office work, nursing care and nursing. In addition, as necessary, a worker move to various places and performs work, and thus, a fixture in which moving means such as casters is provided under the fixture is known.

As the fixture, a fixture is known, which includes a base body in which casters or the like capable of traveling on a floor surface are provided, a support base such as a leg body which extends upward from the base body, and a top plate such as a table which is supported on the upper portion of the support base and on which an article can be placed (refer to Patent Documents 1 and 2 below).

However, in the fixtures described in the following Patent Documents 1 and 2, it is possible to place an article only on the top plate supported on the upper portion of the support base, and thus, the article storage capacity is low, and there is a problem that usability is bad for a user who needs to transport many articles.

Accordingly, a cart device is suggested in which article placing areas such as shelf boards, tray units, or glove boxes capable of placing or accommodating an article are provided to be vertically movable on both sides in a state where the support base is interposed therebetween. Accordingly, the article can be placed on not only the top plate but also the article placing areas provided on both sides of the support base, and thus, the article storage capacity is improved. In addition, it is possible to move the article placing areas vertically according to the height of the accommodated article, and thus, usability is improved (refer to Patent Documents 3 and 4 below).

### CITATION LIST

### Patent Documents

[Patent Document 1] Japanese Unexamined Patent Application, First Publication No. 2009-259243

[Patent Document 2] Japanese Patent No. 2686723

[Patent Document 3] Japanese Unexamined Patent Application, First Publication No. 2014-18386

[Patent Document 4] Japanese Unexamined Patent Application, First Publication No. 2013-17705

### SUMMARY OF INVENTION

### Technical Problem

However, in the cart devices described in Patent Documents 3 and 4, the article placing areas can be provided on both lateral surfaces of both sides in the state where the support base is interposed therebetween. However, the article placing area cannot be provided on other lateral surfaces intersecting both lateral surfaces, a necessary article may not be accommodated, and thus, it is desirable to further increase storage capacity of the article.

The present invention is made in consideration of the above-described circumstances, and an object thereof is to provide a cart device capable of coping with the height of the accommodated article and securing large storage capacity.

### Solution to Problem

In order to achieve the above-described object, the present invention adopts the following means.

That is, a cart device of the present invention includes a base portion which is able to travel on a floor surface, a support body which extends upward from the base portion, article placing members which are disposed on at least three sides around the support body and on which an article is able to be placed, and support means for disposing the article placing members such that a vertical position of each of the article placing members is able to be changed.

In the cart device configured as described above, the article placing members are disposed such that vertical positions thereof are able to be changed by the support means. Therefore, it is possible to change an installation position of each of the article placing members in the vertical direction according to a height of the article accommodated in the article placing members.

In addition, the article placing members are disposed on at least three sides around the support body and the articles can be placed on at least three sides of the support body, and thus, it is possible to secure large storage capacity.

In addition, in the cart device of the present invention, preferably, a plurality of locking holes are formed in the support body, and the support means includes a support bracket which supports the article placing member, and a locking portion which is provided in the support bracket and is locked to the locking hole.

In the cart device configured as described above, the locking portion provided in the support bracket supporting the article placing member is locked to the plurality of locking holes formed in the support body, and thus, the support bracket is attached to the support body. Accordingly, the article placing area can be mounted on the support body side by a simple configuration.

Moreover, in the cart device according to the present invention, the article placing member may include a first article placing area which is disposed in front of the support body, and a second article placing area which is disposed on each of both lateral sides of the support body, and the locking portion of the support bracket which supports the first article placing area may be able to be locked to each locking hole and the locking portion of the support bracket which supports the second article placing area may be able to be locked to each locking hole.

In the cart device configured as described above, the locking portion of the support bracket of the first article placing area disposed in front of the support body and the locking portion of the support bracket of the second article placing areas laterally disposed on each of lateral sides of the support body can be locked to the locking holes. Accordingly, the locking holes for mounting the first article placing area and the locking holes for mounting the second article placing area can be shared, and thus, it is possible to decrease the number of the locking holes.

Moreover, the first article placing area and the second article placing area are disposed in front of the support body and on both lateral sides thereof, and thus, the rear side of the support body can be used as a space other than a space for placing the article. Accordingly, a space for disposing a lower limb of a user who operates the cart device can be secured on the rear side of the support body.

Moreover, in the cart device according to the present invention, the locking holes may be formed on a front surface and a rear surface of the support body, the locking portion of the support bracket which supports the first article placing area may be supported by the locking holes formed on the front surface of the support body, and the locking portion of the support bracket which supports the second article placing area may be supported by the locking holes formed on the front surface of the support body or the locking holes formed on the rear surface of the support body.

In the cart device configured as described above, in a case where the locking portion of the support bracket supporting the second article placing area is locked to the support holes formed on the front surface of the support body, even when the locking holes are not provided on the lateral surfaces of the support body, it is possible to mount the first article placing area disposed in front of the support body and the second article placing areas disposed on both lateral sides of the support body using the locking holes formed on the front surface of the support body.

In addition, in a case where the locking portion of the support bracket supporting the second article placing area is locked to the support holes formed on the rear surface of the support body, even when the locking holes are not provided on the lateral surfaces of the support body, it is possible to mount the first article placing area disposed in front of the support body and the second article placing areas disposed on both lateral sides of the support body using the locking holes formed on the front surface and the rear surface of the support body.

Moreover, in the cart device according to the present invention, the support bracket which supports the first article placing area may extend forward from the locking holes of the support body, and the support bracket which supports the second article placing area may extend laterally from the locking holes of the support body.

In the cart device configured as described above, the support bracket which supports the first article placing area extends forward from the locking holes of the support body, and the support bracket which supports the second article placing area extends laterally from the locking holes of the support body. Accordingly, in the first article placing area and the second article placing area, by causing the extension directions of the support brackets to be different from each other, the locking holes can be shared.

In addition, in the cart device according to the present invention, the first article placing area may be formed to protrude laterally from the support body.

In the cart device configured as described above, the first article placing area is formed to protrude laterally from the support body, and thus, it is possible to secure a large area of the first article placing area in a plan view. Accordingly, it is possible to secure a large storage capacity of the first article placing area.

In addition, in the cart device of the present invention, the second article placing area may be formed to protrude rearward from the support body.

In the cart device configured as described above, the second article placing area is formed to protrude rearward from the support body, and thus, it is possible to secure a large area of the second article placing area in a plan view. Accordingly, it is possible to secure a large storage capacity of the second article placing area.

Moreover, the second article placing area is combined with the first article placing area formed to protrude laterally from the support body, and thus, the first article placing area is disposed in front of the support body and across the front lateral sides thereof and the second article placing area is disposed on the lateral sides of the support body and across the rear lateral sides thereof. Accordingly, the article can be accommodated front the front side of the support body to the lateral sides and the rear lateral sides of the support body, and thus, it is possible to secure larger storage capacity.

### Advantageous Effects of Invention

According to the cart device of the present invention, it is possible to cope with a height of an accommodated article and to secure large storage capacity.

### BRIEF DESCRIPTION OF DRAWINGS

FIG. 1 is a perspective view of a cart device according to an embodiment of the present invention.

FIG. 2 is a perspective view of a first article placing area and second article placing areas included in the cart device according to the embodiment of the present invention.

FIG. 3 is a perspective view of the first article placing area and the second article placing areas included in the cart device according to the embodiment of the present invention, and is a view showing a state where the first article placing area and one second article placing area move downward from the state shown in FIG. 2.

FIG. 4 is a front view showing a support body and a support bracket of the second article placing area included in the cart device according to the embodiment of the present invention.

FIG. 5 is a sectional view taken along line A-A of FIG. 4.

FIG. 6 is a perspective view of the second article placing area included in the cart device according to the embodiment of the present invention.

FIG. 7 is a perspective view showing the support body and the support brackets of the second article placing areas included in the cart device according to the embodiment of the present invention (the second article placing areas are shown by two-dot chain lines).

FIG. 8 is a perspective view including the support body, the second article placing area, and the support bracket of the second article placing area included in the cart device according to the embodiment of the present invention.

FIG. 9A is a top view of a three-sided view of the support bracket of the second article placing area included in the cart device according to the embodiment of the present invention.

FIG. 9B is a side view of a three-sided view of the support bracket of the second article placing area included in the cart device according to the embodiment of the present invention.

FIG. 9C is a front view of a three-sided view of the support bracket of the second article placing area included in the cart device according to the embodiment of the present invention.

FIG. 10 is a partially perspective view of the support bracket of the second article placing area included in the cart device according to the embodiment of the present invention.

FIG. 11 is a sectional view taken along line B-B of FIG. 7.

FIG. 12 is a sectional view taken along line C-C of FIG. 7.

FIG. 13 is a perspective view of a part interposed between the support bracket of the second article placing area and the second article placing area included in the cart device according to the embodiment of the present invention.

FIG. 14 is a sectional view taken along line D-D of FIG. 5.

FIG. 15 is a perspective view showing an operation of attaching the support brackets of the second article placing areas included in the cart device according to the embodiment of the present invention to the support body of the cart device.

FIG. 16A is a perspective view of the first article placing area included in the cart device according to the embodiment of the present invention and is a perspective view when viewed from above.

FIG. 16B is a perspective view of the first article placing area included in the cart device according to the embodiment of the present invention and is a perspective view when viewed from below.

FIG. 17A is a bottom view of a three-sided view of the first article placing area included in the cart device according to the embodiment of the present invention.

FIG. 17B is a side view of a three-sided view of the first article placing area included in the cart device according to the embodiment of the present invention.

FIG. 17C is a front view of a three-sided view of the first article placing area included in the cart device according to the embodiment of the present invention.

FIG. 18 is a perspective view showing the base portion, the support body, and the support bracket of the first article placing area of the cart device according to the embodiment of the present invention (a perspective view in which the first article placing area, the support bracket of the second article placing area, and the second article placing area are omitted).

FIG. 19 is a perspective view when the support bracket of the first article placing area included in the cart device according to the embodiment of the present invention is viewed from above in a state where the first article placing area is removed.

FIG. 20 is a perspective view when the support bracket of the first article placing area included in the cart device according to the embodiment of the present invention is viewed from below in a state where the first article placing area is removed.

FIG. 21 is a bottom view when the support bracket of the first article placing area included in the cart device according to the embodiment of the present invention is viewed from below in a state where the first article placing area is attached.

FIG. 22 is a partially enlarged side view of a portion on the support body side of the support bracket of the first article placing area included in the cart device according to the embodiment in the state where the first article placing area is removed.

FIG. 23A is a perspective view of a lock member included in the cart device according to the embodiment of the present invention and is a perspective view when the cart device is viewed from the front side.

FIG. 23B is a perspective view of the lock member included in the cart device according to the embodiment of the present invention and is a perspective view when the cart device is viewed from the rear side.

FIG. 24A is a schematic view showing an operation when the first article placing area is mounted on the support bracket included in the cart device according to the embodiment of the present invention.

FIG. 24B is a schematic view showing the operation when the first article placing area is mounted on the support bracket included in the cart device according to the embodiment of the present invention.

FIG. 25A is a schematic view showing the operation when the first article placing area is mounted on the support bracket included in the cart device according to the embodiment of the present invention.

FIG. 25B is a schematic view showing the operation when the first article placing area is mounted on the support bracket included in the cart device according to the embodiment of the present invention.

FIG. 26A is a schematic view showing an operation when the support bracket of the first article placing area is detached from the support body included in the cart device according to the embodiment of the present invention.

FIG. 26B is a schematic view showing the operation when the support bracket of the first article placing area is detached from the support body included in the cart device according to the embodiment of the present invention.

FIG. 27A is a schematic view showing the operation when the support bracket of the first article placing area is detached from the support body included in the cart device according to the embodiment of the present invention.

FIG. 27B is a schematic view showing the operation when the support bracket of the first article placing area is detached from the support body included in the cart device according to the embodiment of the present invention.

### DESCRIPTION OF EMBODIMENTS

Hereinafter, an embodiment of a cart device according to the present invention will be described with reference to the drawings. Hereinafter, in the following drawings, a scale of each member is appropriately changed such that the member is shown to be a recognizable size.

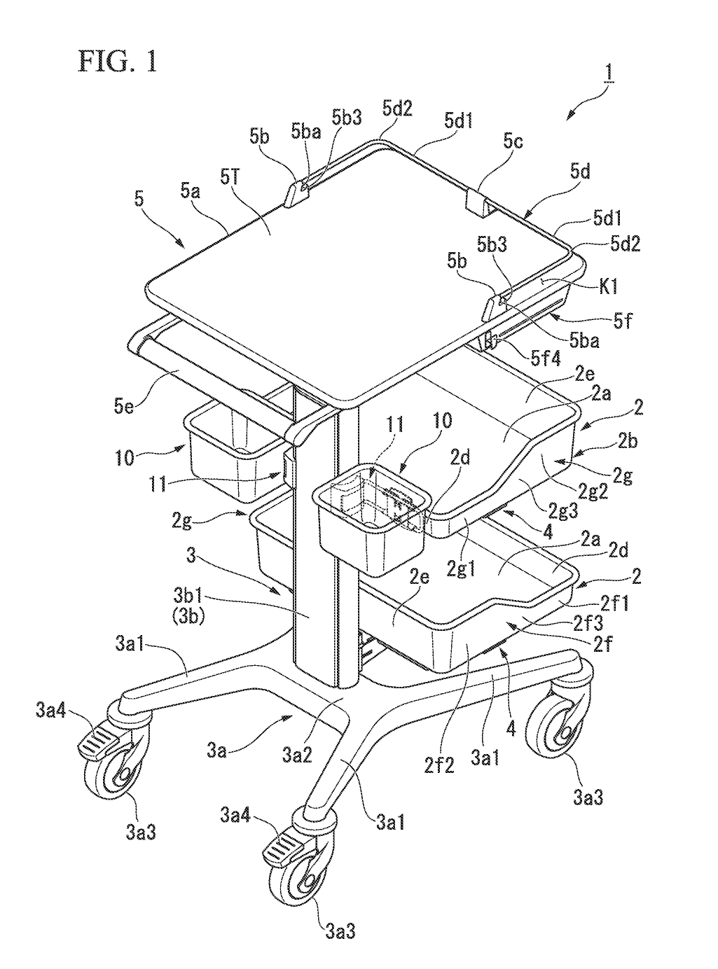

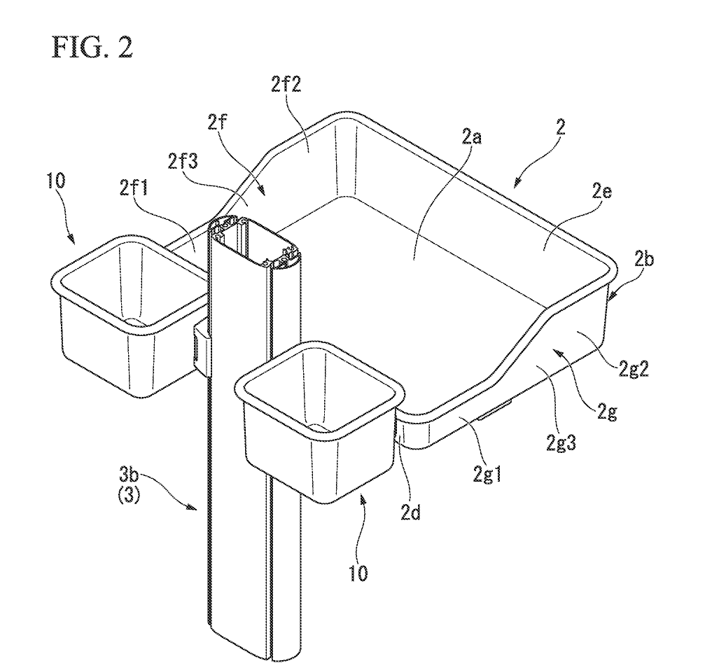

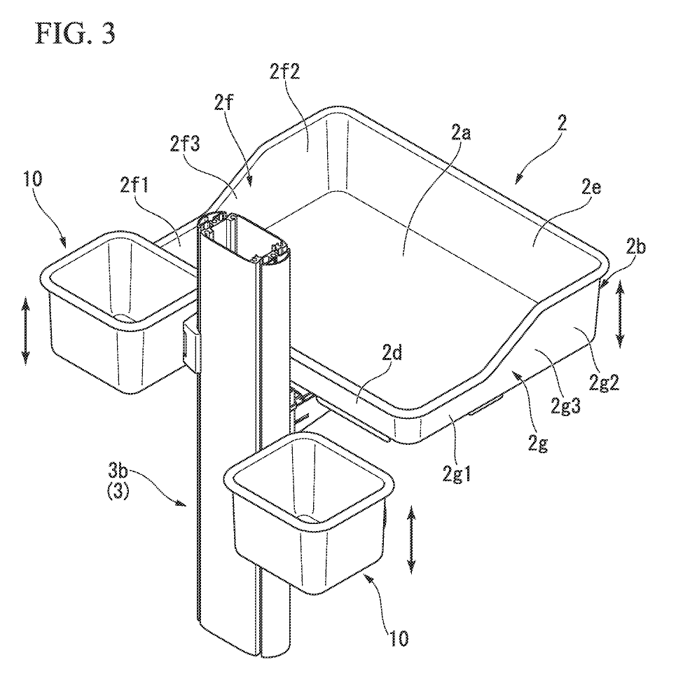

FIG. 1 is a perspective view of the cart device according to the embodiment of the present invention. FIG. 2 is a perspective view showing a first article placing area and second article placing areas included in the cart device according to the embodiment of the present invention. FIG. 3 is a perspective view showing the first article placing area and the second article placing areas included in the cart device according to the embodiment of the present invention, and is a view showing a state where the first article placing area and one second article placing area move downward from the state shown in FIG. 2.

Moreover, in the following descriptions, a side where a user grips a handle 5c and opposes the cart device 1 is referred to a rear side and a side where the user presses the handle 5e to move the cart device 1 forward is referred to as a front side. A direction in which the rear side and the front side are connected to each other is referred to as a front-rear direction or a depth direction. In addition, a horizontal direction orthogonal to the front-rear direction is referred to as a width direction. In addition, with a direction in which the user grips the handle 5e and operates the cart device 1 as a reference, the right side (a front right side on a page surface of FIG. 1) is referred to as a right side and the left side (a left rear side on the page surface of FIG. 1) is referred to as a left side.

The cart device 1 is a fixture which places and transports articles such as document files and drug bottles in offices and hospitals. As shown in FIG. 1, the cart device 1 includes a cart body 3 which is installed on a floor surface, pocket trays (second article placing areas, article placing member) 10 which are supported by the cart body 3, pocket tray support mechanisms (support means) 11 which support the pocket trays 10, main trays (first article placing areas, article placing member) 2 which is supported by the can body 3, main tray support mechanisms (support means) 4 which support the main trays 2, and a top plate unit 5 which is supported by the cart body 3. As shown in FIGS. 2 and 3, in the cart device 1, the pocket trays 10 and the main tray 2 are mounted such that vertical positions thereof with respect to the cart body 3 can be changed.

(Cart Body)

As shown in FIG. 1, the cart body 3 includes a leg portion (first base portion) 3a, a support base (support body) 3b, and a lifting/lowering operation portion (not shown). The leg portion 3a includes four linear leg rods 3a1, a second base portion 3a2 to which roots of the leg rod 3a1 are connected, a caster 3a3 attached to a tip portion of each leg rod 3a1, and first lock portions 3a4 which lock the casters 3a3. The casters 3a3 of the leg portion 3a roll on the floor surface in a state of being abutting on the floor surface, and thus, the cart device 1 can travel. In addition, the casters 3a3 are locked by the first lock portions 3a4, and thus, the movement of the cart device 1 is regulated.

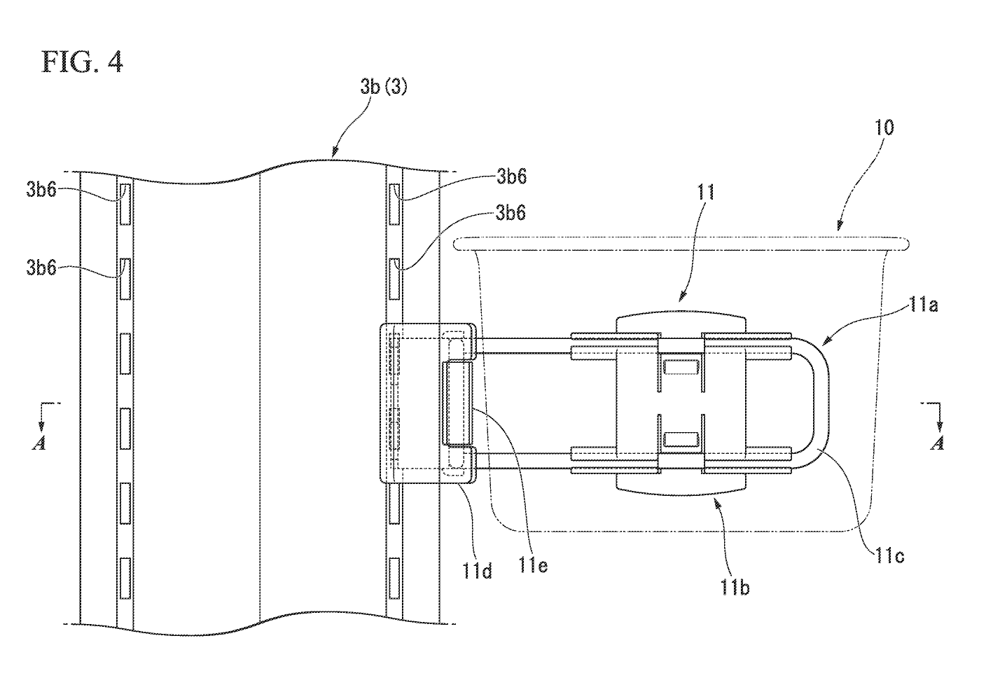

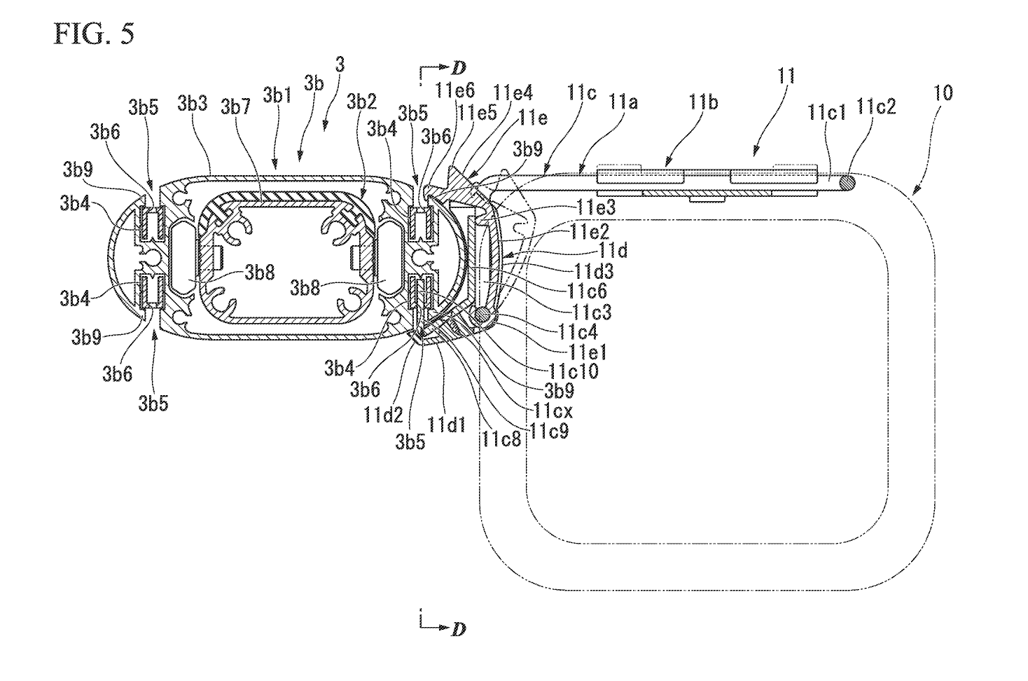

FIG. 4 is a front view including the support base 3b and the pocket tray support mechanism 11. FIG. 5 is a sectional view taken along line A-A of FIG. 4. In FIGS. 4 and 5, only one pocket tray support mechanism 11 is shown.

As shown in FIGS. 4 and 5, the support base 3b includes an outer column unit 3b1 and an inner column unit 3b2. The outer column unit 3b1 includes an outer 3b3 which is a hollow columnar portion uprightly standing on the second base portion 3a2 (refer to FIG. 1, the same is applied to the following) of the leg portion 3a (refer to FIG. 1, the same is applied to the following), and shelf posts 3b4 which are fixed to the outer 3b3. In the outer 3b3, two first groove portions 3b5 are formed on each of the front side and the rear side of the cart device 1. The two first grooves portions 3b5 are formed to vertically extend in a state of being parallel to each other. Each of the shelf posts 3b4 is fitted to each of the first groove portions 3b5 of the outer 3b3. That is, in the present embodiment, two shelf posts 3b4 are provided on each of the front side and the rear side of the cart device 1, and thus, total of four shelf posts 3b4 are provided. In each shelf post 3b4, locking holes 3b6 are formed at a constant pitch in the vertical direction. The locking holes 3b6 are portions into which locking claws 11c10 and 4g3 described later included in tray support means 11 and 4 described later are inserted.

The inner column unit 3b2 includes a hollow columnar portion 3b7 which is inserted into the outer 3b3 of the outer column unit 3b1 and has an upper end to which the top plate unit 5 is fixed, and rollers 3b8 which are pivoted by side portions of the columnar portion 3b7 and abut an inner wall surface of the outer 3b3 of the outer column unit 3b1. The inner column unit 3b2 can vertically move inside the outer 3b3 of the outer column unit 3b1 by rolling the rollers 3b8. In a case where the inner column unit 3b2 largely protrudes upward from the outer column unit 3b1, the entire support base 3b extends, and thus, the top plate unit 5 (refer to FIG. 1, the same is applied to the following) is disposed at a high position. Meanwhile, in a case where most of the inner column unit 3b2 is accommodated in the outer column unit 3b1, the entire support base 3b is contracted, and thus, the top plate unit 5 is disposed at a low position.

As shown in FIG. 1, the lifting/lowering operation portion (not shown, the same is applied to the following) includes an operation lever (not shown) and a lock mechanism (not shown). The operation lever is disposed below the handle 5e, and the lock of the inner column unit 3b2 is released by the lock mechanism by operating the operation lever.

The lock mechanism fixes the inner column unit 3b2 to the outer column unit 3b1 and releases the lock only in a case where the operation lever is operated. It is possible to dispose the top plate unit 5 at an arbitrary height by the lifting/lowing operation portion.

(Pocket Tray)

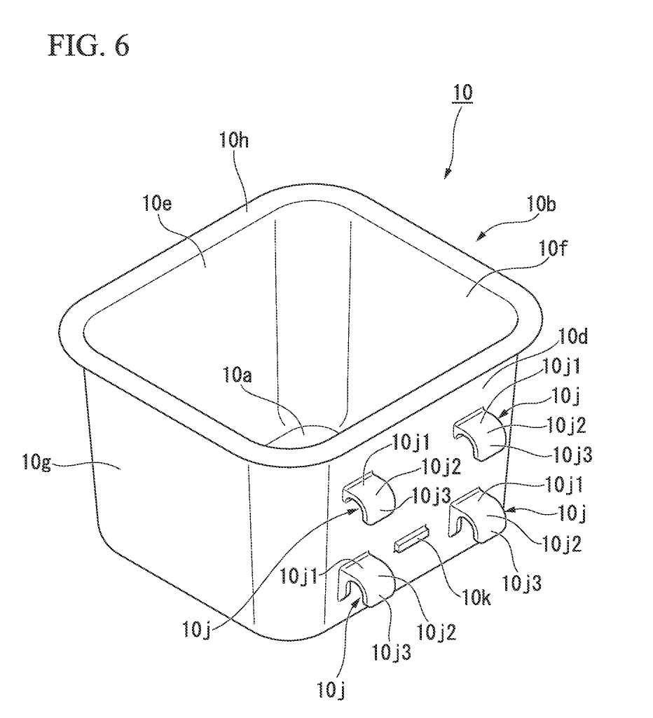

FIG. 6 is a perspective view of the pocket tray 10.

As shown in FIG. 6, the pocket tray 10 includes a bottom plate 10a, a peripheral wall portion 10b which uprightly stands on an edge portion of the bottom plate 10a, and downward claws 10j and an engagement piece 10k which are formed on a front portion of the peripheral wall portion 10b.

The bottom plate 10a is an article placing surface having a flat upper surface and is a plate-shaped portion which supports the placed article from below. In the present embodiment, the bottom plate 10a has an approximately square shape.

The peripheral wall portion 10b is a wall portion which uprightly stands on the edge portion of the bottom plate 10a to surround the bottom plate 10a, and includes a front wall 10d which uprightly stands from a side positioned at the front portion of the bottom plate 10a in the cart device 1, a rear wall 10e which uprightly stands from a side positioned at the rear portion of the bottom plate 10a in the cart device 1, a first side wall 10f which uprightly stands from a first side of the bottom plate 10a in the width direction of the cart device 1, and a second side wall 10g which uprightly stands from a second side of the bottom plate 10a in the width direction of the cart device 1.

A folded wall portion 10h folded outward is continuously provided on upper end portions of the front wall 10d, the first side wall 10f the rear wall 10e, and the second side wall 10g.

The downward claws 10j are provided at four locations on the front wall 10d of the peripheral wall portion 10b to be separated from each other in the width direction and the vertical direction. Each downward claw 10j includes a first flat surface portion 10j which protrudes along a horizontal surface from the front wall 10d, a curved portion 10j2 which is formed to be gradually curved downward from an end portion of the first flat surface portion 10j1 toward the front side, and a second flat surface portion 10j3 which extends along a vertical surface from an end portion of the curved portion 10j2. In this way, the downward claw 10j is formed in a downward hook shape. The downward claw 10j is formed so as to be elastically deformable. For example, an intervening member 11b is formed of a synthetic resin such as polypropylene (PP).

The engagement piece 10k is disposed between two downward claws 10j which are disposed on the lower side among the downward claws 10j which are disposed to be vertically separated from each other on the front wall 10d of the peripheral wall portion 10b. The engagement piece 10k protrudes forward from the front wall 10d and is formed horizontally.

In addition, as shown in FIG. 5, a dimension of the pocket tray 10 in the front-rear direction of the cart device 1 is longer than a dimension of the support base 3b in the front-rear direction.

(Pocket Tray Support Mechanism)

As shown in FIG. 1, in the present embodiment, two pocket tray support mechanisms 11 are provided with respect to the can body 3. The pocket tray support mechanisms 11 are disposed at both sides in the width direction of the cart device 1 in a state where the support base 3b is interposed therebetween. Each of the pocket tray support mechanism 11 is detachably mounted on the support base 3b and supports the pocket tray 10.

In addition, the pocket tray support mechanisms 11 have the same configuration except that the disposition directions thereof are different from each other, and thus, in the following descriptions, one pocket tray support mechanism 11 is described.

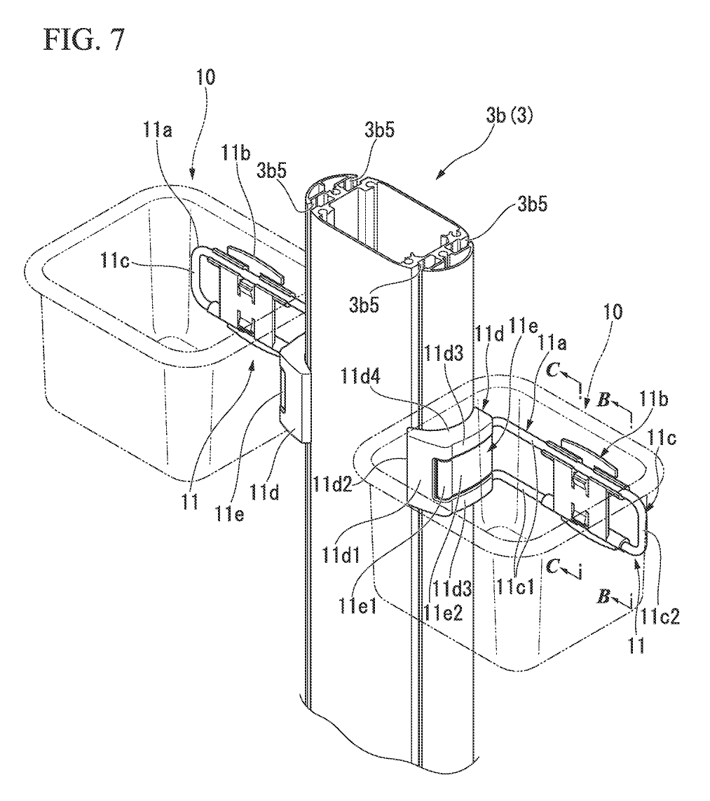

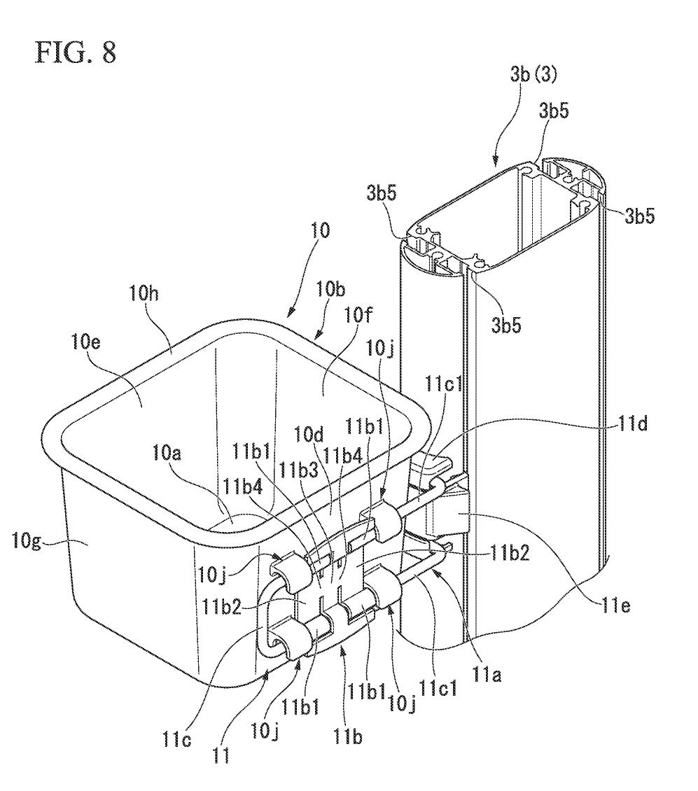

FIG. 7 is a perspective view including the support base 3b and the pocket tray support mechanisms 11 (the pocket trays 10 are shown by two-dot chain lines). FIG. 8 is a perspective view including the support base 3b, the pocket tray 10, and the pocket tray support mechanism 11.

As shown in FIGS. 7 and 8, the pocket tray support mechanism 11 includes a bracket member (support bracket of second article placing area) 11a and an intervening member 11b.

The bracket member 11a includes a hanger portion 11c, a cover portion 11d, and a second lock portion 11e.

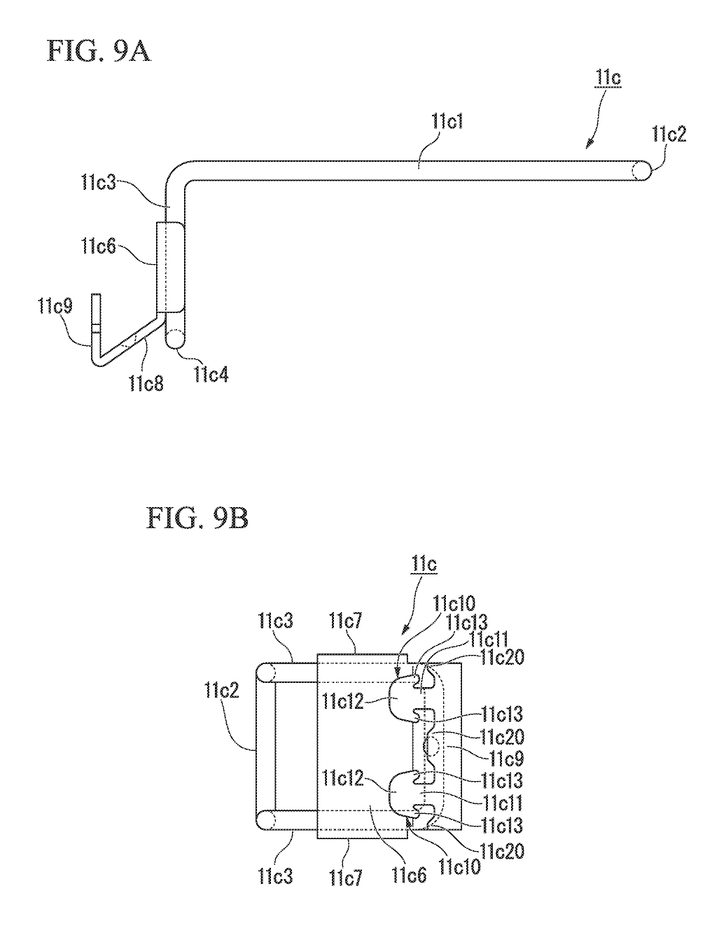

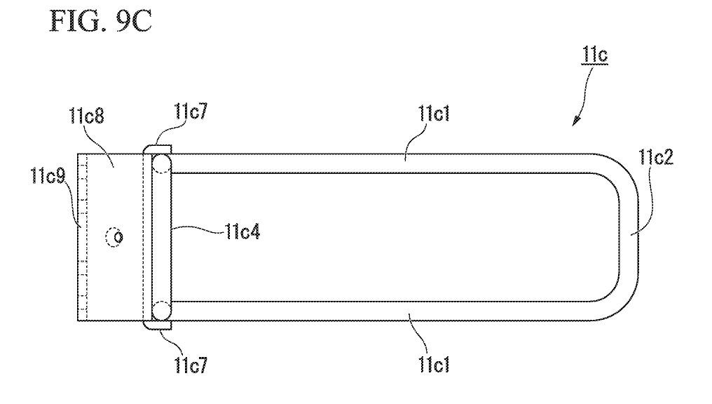

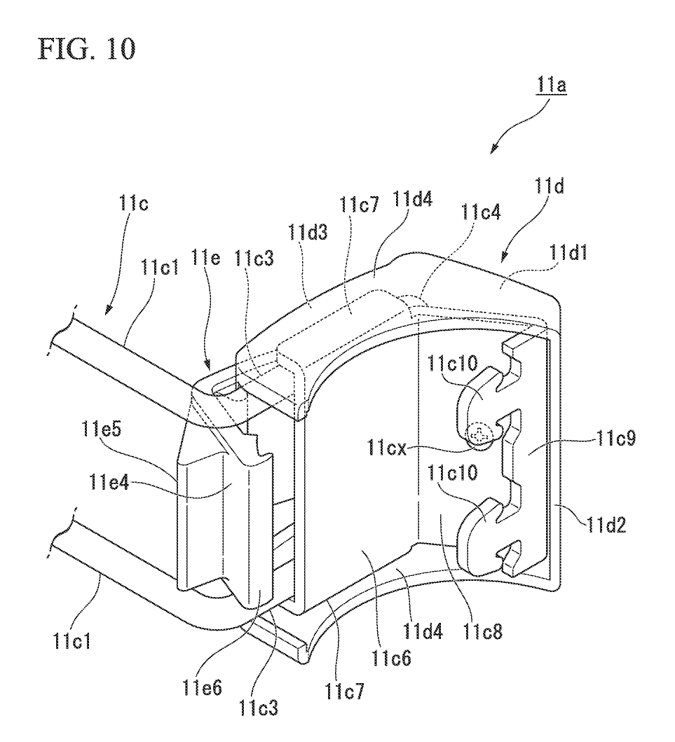

FIGS. 9A to 9C are three-sided views of the hanger portion 11c. FIG. 9A is a top view, FIG. 9B is a side view, and FIG. 9C is a front view. FIG. 10 is a partially perspective view of the bracket member 11a.

As shown in FIGS. 9A to 9C and 10, the hanger portion 11c includes two linear wire portions 11c1, a first connection wire portion 11c2, bent wire portions 11c3, a second connection wire portion 11c4, a main plate-shaped portion 11c6, end plate-shaped portions 11c7, a first curved plate-shaped portion 11c8, a second curved plate-shaped portion 11c9, and locking claws (locking portions) 11c10.

As shown in FIGS. 8, 9A to 9C, and 10, the linear wire portions 11c1 engage with the downward claws 10j of the pocket tray 10 in a state where the intervening member 11b described later is interposed therebetween. The two linear wire portions 11c1 are disposed to be separated from each other in the vertical direction so as to correspond to a gap between the downward claws 10j in the vertical direction. The first connection wire portion 11c2 connects end portions of the two linear wire portions 11c1 on a first end (the outside of the cart device 1 in the width direction). Each of the bent wire portions 11c3 is bent along a lateral surface of the support base 3b from an end portion of each linear wire portion 11c1 on a second end (the inside of the cart device 1 in the width direction). The second connection wire portion 11c4 connects rear end portions of the two bent wire portions 11c3 to each other. In the present embodiment, the linear wire portions 11c1, the first connection wire portion 11c2, the bent wire portions 11c3 and, the second connection wire portion 11c4 are integrally formed of a wire steel rod.

The main plate-shaped portion 11c6 is provided along surfaces of the two bent wire portions 11c3 on the support base 3b side. The end plate-shaped portions 11c7 are provided so as to be bent from upper and lower end portions of the main plate-shaped portion 11c6. The end plate-shaped portions 11c7 are disposed along the upper and lower surfaces of the two bent wire portions 11c3. The first curved plate-shaped portion 11c8 is bent from a rear end portion of the main plate-shaped portion 11c6 and is gradually inclined toward a center side of the cart device 1 in the width direction as going backward. The second curved plate-shaped portion 11c9 is provided to be bent forward front a rear end portion of the first curved plate-shaped portion 11c8. The second curved plate-shaped portion 11c9 is disposed in the first groove portion 3b5 of the support base 3b. The locking claws 11c10 are provided at two locations vertically separated from each other on the end portion of the second curved plate-shaped portion 11c9. In addition, abutment wall portions 11c20 protruding toward the locking claws 11c10 are provided on the end portion of the second curved plate-shaped portion 11c9. The abutment wall portions 11c20 are provided at three locations between the upper and lower end portions of the second curved plate-shaped portion 11c9, the upper locking claw 11c10, and the lower locking claw 11c10.

As shown in FIGS. 9A to 9C, each locking claw 11c10 includes a base portion 11ic11 which is provided on the end portion of the second curved plate-shaped portion 11c9, a wide portion 11c12 which is continued to the base portion 11c11 and is formed to be wider than a vertical width of the base portion 11c11, and engagement claw portions 11c13 which extend toward the end portion side of the second curved plate-shaped portion 11c9 from upper and lower end portions of the wide portion 11c12.

In the present embodiment, the main plate-shaped portion 11c6, the end plate-shaped portions 11c7, the first curved plate-shaped portion 11c8, the second curved plate-shaped portion 11c9, and the locking claws 11c10 are integrally formed of a sheet metal or the like. In addition, the bent wire portions 11c3, the upper and lower end portions of the main plate-shaped portion 11c6, and the end plate-shaped portion 11c7 are connected to each other by welding or the like. The hanger portion 11c is symmetrical with respect to the center in the vertical direction.

As shown in FIGS. 5, 7, and 10, the cover portion 11d includes a fixing wall portion 11d1, an end wall portion 11d2, an extension wall portion 11d3, and upper and lower wall portions 11d4.

The fixing wall portion 11d1 is disposed along the first curved plate-shaped portion 11c8 of the hanger portion 11c. A screw 11cx which is inserted from an attachment hole (not shown) formed in the first curved plate-shaped portion 11c8 is screwed to the fixing wall portion 11d1, and as a result, the fixing wall portion 11d1 is fixed to the first curved plate-shaped portion 11c8. The end wall portion 11d2 is bent from an inner end portion of the fixing wall portion 11d1 in the width direction of the cart device 1, and is disposed to cover a corner portion between the first curved plate-shaped portion 11c8 and the second curved plate-shaped portion 11c9 of the hanger portion 11c. The extension wall portion 11d3 is formed to extend forward from upper and lower end portions of the outer end portions of the fixing wall portion 11d1 in the width direction of the cart device 1. The extension wall portion 11d3 is disposed outside the bent wire portions 11c3 of the hanger portion 11c in the width direction of the cart device 1. The upper and lower wall portions 11d4 are formed to cover the upper side and the lower side of the hanger portion 11c from the extension wall portion 11d3. The cover portion 11d is symmetrical with respect to the center in the vertical direction.

The second lock portion 11e includes a shaft locking portion 11e1, an extension wall portion 11e2, a pressing protrusion portion 11e3, a bent wall portion 11e4, a knob portion 11e5, and a locking claw portion 11e6.

The shaft locking portion 11e1 is formed in an arc shape to lock an outer peripheral surface of the second connection wire portion 11c4 of the hanger portion 11c.

The shaft locking portion 11e1 is disposed between the upper extension wall portion 11d3 and the lower extension wall portion 11d3 of the cover portion 11d. The extension wall portion 11e2 extends forward from an end portion of the shaft locking portion 11e1 and is disposed between the upper bent wire portion 11c3 and the lower bent wire portion 11c3 of the hanger portion 11c. The pressing protrusion portion 11e3 protrude from the inner surface of the extension wall portion 11e2 in the width direction of the cart device 1 toward the main plate-shaped portion 11c6 of the hanger portion 11c. A tip portion of the pressing protrusion portion 11e3 abuts the main plate-shaped portion 11c6. The bent wall portion 11e4 is inclined to be gradually inclined forward from the end portion of the extension wall portion 11e2 toward the inside in the width direction of the cart device 1. The knob portion 11e5 is formed to protrude forward from a front end portion of the bent wall portion 11e4. The locking claw portion 11e6 is formed to be recessed forward on a rear end portion of the bent wall portion 11e4. The locking claw portion 11e6 is locked to the protrusion portion 3b9 positioned on one side (the outside in the width direction of the cart device 1) of the outer 3b3 of the support base 3b with the first groove portions 3b5 between them. The second lock portion 11c is symmetrical with respect to the center in the vertical direction.

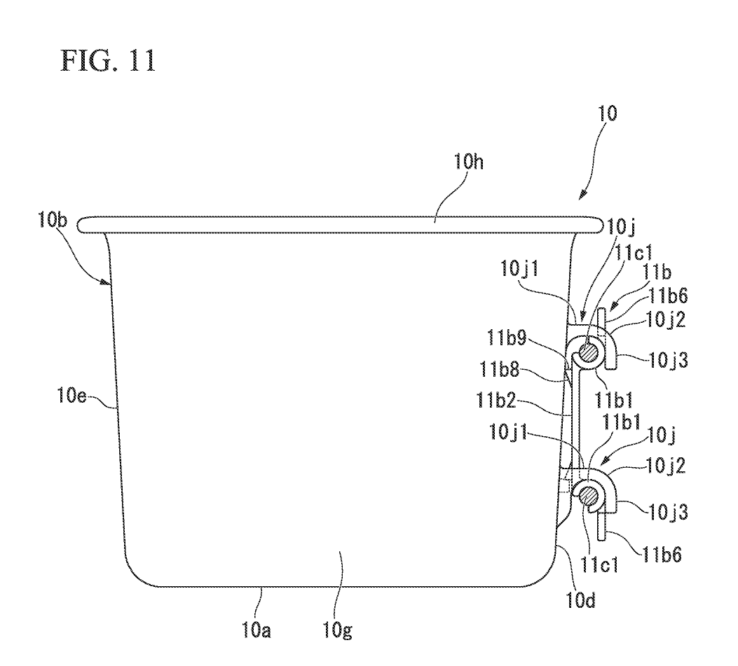

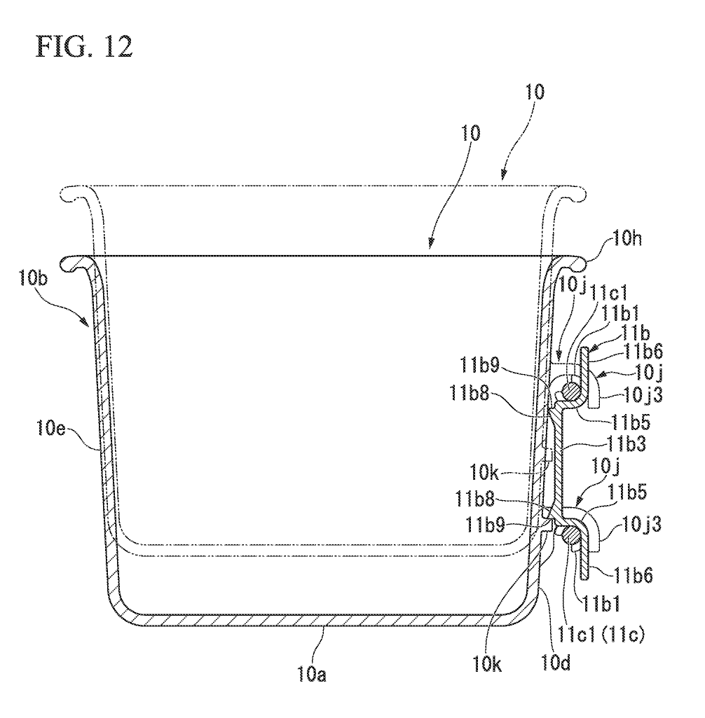

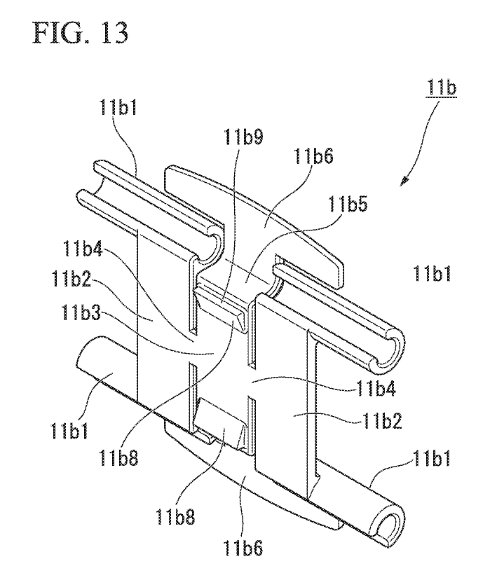

FIG. 11 is a sectional view taken along line B-B of FIG. 7. FIG. 12 is a sectional view taken along line C-C of FIG. 7. FIG. 13 is a perspective view of the intervening member 11b.

As shown in FIGS. 11, 12, and 13, the intervening member 11b includes wire fitting portions 11b1, vertical connection portions 11b2, a central wall portion 11b3, horizontal connection portions 11b4, slip-off stopping pieces 11b8, support wall portions 11b5, and lever pieces 11b6. The intervening member 11b is formed so as to be elastically deformable. For example, the intervening member 11b is formed of a synthetic resin such as polypropylene (PP).

The wire fitting portions 11b1 are disposed at four locations separated from each other in the width direction and the vertical direction of the cart device 1. The wire fitting portions 11b1 which are disposed on the upper side are open toward the rear upper side. The wire fitting portions 11b1 which are disposed on the lower side are open toward the rear lower side. The upper wire fitting portions 11b1 engage with the upper linear wire portion 11c1 of the bracket member 11a while being elastically deformed to the upper linear wire portion 11c1. The lower wire fitting portions 11b1 engage with the lower linear wire portion 11c1 of the bracket member 11a while being elastically deformed to the upper linear wire portion 11c1.

The vertical connection portions 11b2 connect the upper wire fitting portions 11b1 and the lower wire fitting portions 11b1 to each other. Each of the vertical connection portions 11b2 is formed in a plate shape and is disposed along the vertical surface. The vertical connection portions 11b2 are provided at two locations separated from each other in the width direction of the cart device 1 to connect first sides in the width direction of the cart device 1 to each other and connect second sides in the width direction thereof to each other.

The central wall portion 11b3 is disposed between the pair of vertical connection portions 11b2. The central wall portion 11b3 is formed in a plate shape and is disposed along the vertical surface.

The horizontal connection portions 11b4 connect the central wall portion 11b3 and the vertical connection portions 11b2 on both sides in the width direction of the cart device 1 to each other. Each of the horizontal connection portions 11b4 is formed in a plate shape and is disposed along the vertical surface. The horizontal connection portions 11b4 are provided to be positioned at the center of the central wall portion 11b3 in the vertical direction. That is, the upper and lower sides of the horizontal connection portions 11b4 and the central wall portion 11b3 are not connected to each other.

The slip-off stopping pieces 11b8 protrude from the central wall portion 11b3 toward the front wall 10d side of the pocket tray 10. The slip-off stopping pieces 11b8 are provided on the upper portion and the lower portion of the central wall portion 11b3. Each of the slip-off stopping pieces 11b8 includes an engagement surface 11b9 which is formed along the horizontal surface.

Each of the support wall portions 11b5 is provided on an upper end portion and a lower end portion of the central wall portion 11b3. The upper support wall portion 11b5 is formed to be curved along the front surface from the lower surface of the upper linear wire portion 11c1. The lower support wall portion 11b5 is formed to be curved along the front surface form the upper surface of the lower linear wire portion 11c1.

Each of the lever pieces 11b6 is provided to be continued to each support wall portion 11b5. The upper lever piece 11b6 is formed to extend upward from the support wall portion 11b5. The lower lever piece 11b6 is formed to extend downward from the support wall portion 11b5. The intervening member 11b is symmetrical with respect to the center in the vertical direction, and is symmetrical with respect to the center in the width direction.

In this way, the pocket tray support mechanism 11 including the bracket member 11a and the intervening member 11b is symmetrical with respect to the center in the vertical direction. Accordingly, by reversing the top and bottom of the pocket tray support mechanism 11, the pocket tray support mechanisms 11 can be provided on both sides of the width direction of cart device 1.

Subsequently, in the cart device 1 having the above-described configuration, an operation when the pocket tray support mechanism 11 and the pocket tray 10 are mounted on the support base 3b will be described.

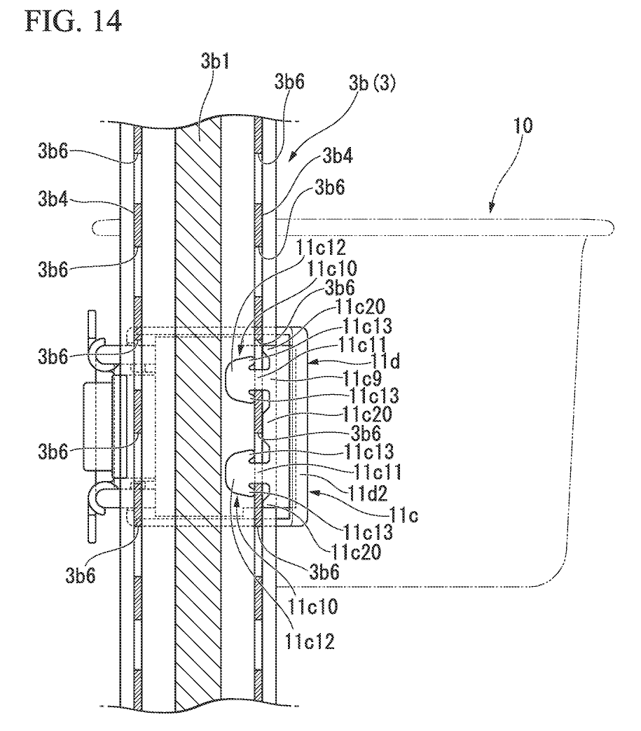

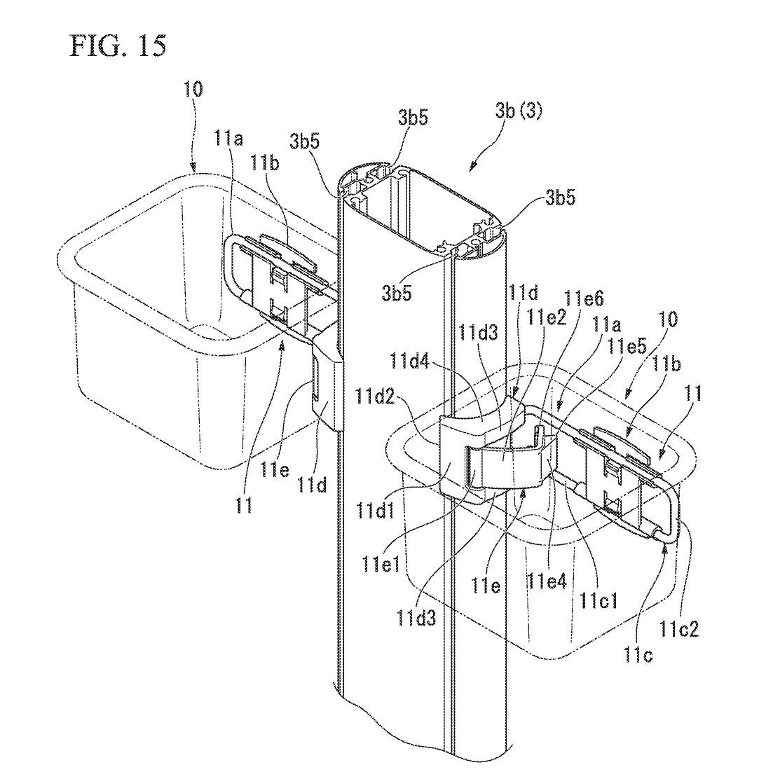

FIG. 14 is a sectional view taken along line D-D of FIG. 5. FIG. 15 is a perspective view showing an operation of attaching the pocket tray 10 to the support base 3b.

First, the wiring fitting portions 11b1 of the intervening member 11b are fitted into the linear wire portions 11c1 of the bracket member 11a.

In this state, as shown in FIGS. 5 and 14, the locking claws 11c10 of the hanger portion 11c are locked to the locking holes 3b6 of the shelf posts 3b4 of the cart body 3. A vertical arrangement pitch of the locking claws 11c10 are the same as the arrangement pitch of the locking holes 3b6 of the shelf posts 3b4 of the cart body 3. The distance from an upper end of the upper engagement claw portion 11c13 of each locking claw 11c10 to a lower end of the lower engagement claw portion 11c13 is slightly shorter than the vertical length of the locking hole 3b6. Accordingly, by moving the locking claws 10c10, which pass through the locking holes 3b6 and are inserted into the locking holes 3b6, downward, the base portions 11c11 of the locking claws 11c10 are disposed on the lower portions of the locking holes 3b6 of the shelf posts 3b4 to be locked to the shelf posts 3b4, and thus, a downward movement of the hanger portion 11c is regulated. In addition, the engagement claw portions 11c13 of the locking claws 11c10 are locked to the front surfaces of the shelf posts 3b4, and thus, a rearward movement of the hanger portion 11c is regulated. In addition, the abutment wall portions 11c20 are locked to the rear surfaces of the shelf posts 3b4, and thus, a forward movement of the hanger portion 11c is regulated. In this state, the hanger portion 11c is disposed such that the linear wire portions 11c1 extend to the lateral side of the support base 3b.

In addition, as shown in FIG. 15, in the bracket member 11a, the locking claw portion 11e6 of the second lock portion 11e is locked to the protrusion portion 3b9 (refer to FIG. 5, the same is applied to the following) of the support base 3b. Accordingly, in the second lock portion 11e, the locking claw portion 11e6 is locked to the protrusion portion 3b9 of the support base 3b while the shaft locking portion 11e1 engages with the second connection wire portion 11c4 of the hanger portion 11c.

In this way, the second lock portion 11e is mounted on the hanger portion 11c and the support base 3b.

In this state, the tip portion of the pressing protrusion portion 11e3 of the second lock portion 11e abuts the main plate-shaped portion 11c6 of the hanger portion 11c. Accordingly, the hanger portion 11c is pressed to the support base 3b side, and in the hanger portion 11c, the rotation of the first connection wire portion 11c2 side rearward about the locking claws 11c10 is regulated.

In addition, as shown in FIGS. 11 and 12, in the wire fitting portions 11b1 of the intervening member 11b to which the linear wire portions 11c1 are fitted, the pocket tray 10 is moved downwardly such that the downward claws 10j of the pocket tray 10 engage with the wire fitting portions 11b1. In this case, the engagement piece 10k of the pocket tray 10 gets over the lower slip-off stopping piece 11b8 of the intervening member 11b. In addition, the linear wire portions 11c1 to which the intervening member 11b is fitted are disposed inside the downward claws 10j of the pocket tray 10, and the downward claws 10j engage with outer peripheries of the wire fitting portions 11b1 of the intervening member 11b from above. In this state, the second flat surface portions 10j3 of the downward claws 10j abut the front surfaces of the wire fitting portions 11b1, and thus, a rearward movement of the pocket tray 10 is regulated. In addition, the upper slip-off stopping piece 11b8 abuts the front wall 10d of the pocket tray 10, and thus, a forward movement of the pocket tray 10 is regulated. In addition, the engagement piece 10k of the pocket tray 10 abuts the engagement surface 11b9 of the intervening member 11b, and thus, an upward movement of the pocket tray 10 is regulated. In this way, the mounting of the pocket tray 10 with respect to the lateral sides of the support base 3b is completed.

In this state, as shown in FIG. 5, the linear wire portions 11c1 of the hanger portion 11c are disposed to be flush with the front surface of the support base 3b. The pocket tray 10 is disposed behind the linear wire portions 11c1 of the hanger portion 11c. In addition, a dimension of the pocket tray 10 in the front-rear direction of the cart device 1 is longer than a dimension of the support base 3b in the front-rear direction. Accordingly, the pocket tray 10 protrudes rearward from the support base 3b.

In addition, here, the example in which the bracket member 11a is mounted on the rear locking holes 3b6 of the support base 3b. However, in the cart device 1 of the present embodiment, it is possible to mount the bracket member 11a on the front locking holes 3b6 of the support base 3b.

Subsequently, an operation of detaching the pocket tray support mechanism 11 and the pocket tray 10 from the support base 3b will be described.

If the lower lever piece 11b6 of the intervening member 11b is pulled rearward, the upper and lower sides of the horizontal connection portions 11b4 and the central wall portion 11b3 are not connected to each other, and thus, the slip-off stopping pieces 11b8 are elastically deformed such that the tip sides thereof move rearward with the horizontal connection portion 11b4 as a base end side, and the engagement between the slip-off stopping piece 11b8 and the engagement piece 10k is released. Accordingly, the pocket tray 10 can move vertically, and thus, the pocket tray 10 is removed. In addition, the locking claw portion 11e6 of the second lock portion 11e is removed from the protrusion portion 3b9 of the support base 3b. In addition, the hanger portion 11c is moved slightly upward and moved rearward. Accordingly, the wide portions 11c12 of the locking claws 11c10 of the hanger portion 11c pass through the locking holes 3b6 of the support base 3b, and thus, the pocket tray support mechanism 11 and the pocket tray 10 are detached from the support base 3b.

In addition, in the detached pocket tray support mechanism 11 and pocket tray 10, the locking claws 11c10 are locked to the locking holes 3b6 formed at positions different from the original positions, and thus, it is possible to appropriately change the vertical position of the pocket tray 10 to mount the pocket tray 10 on the support base 3b side.

(Main Tray)

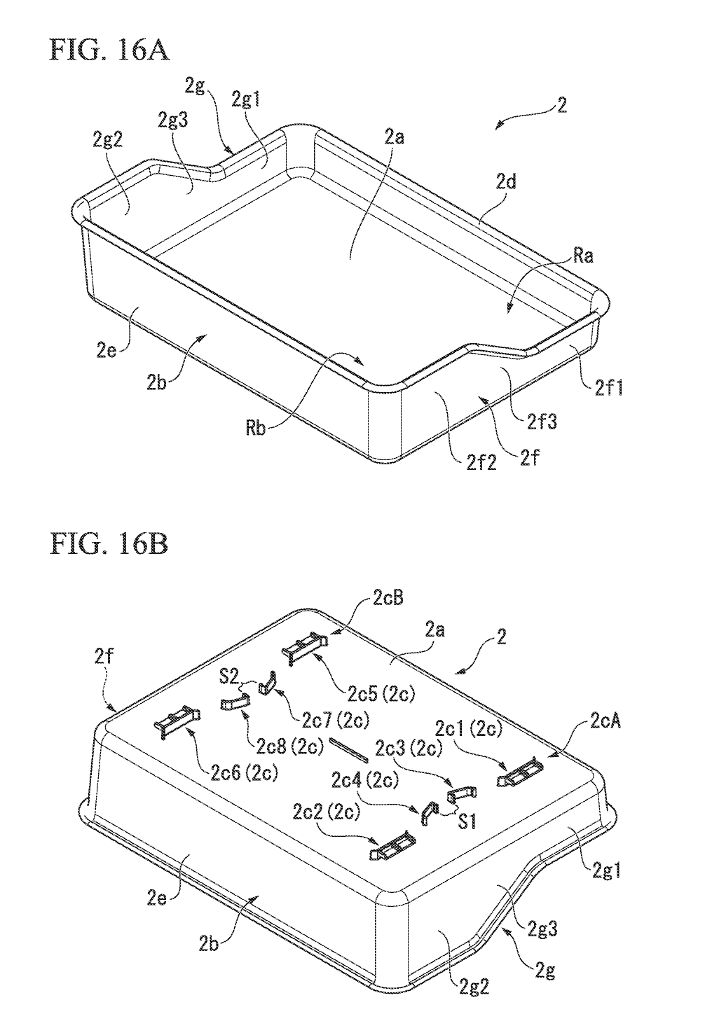

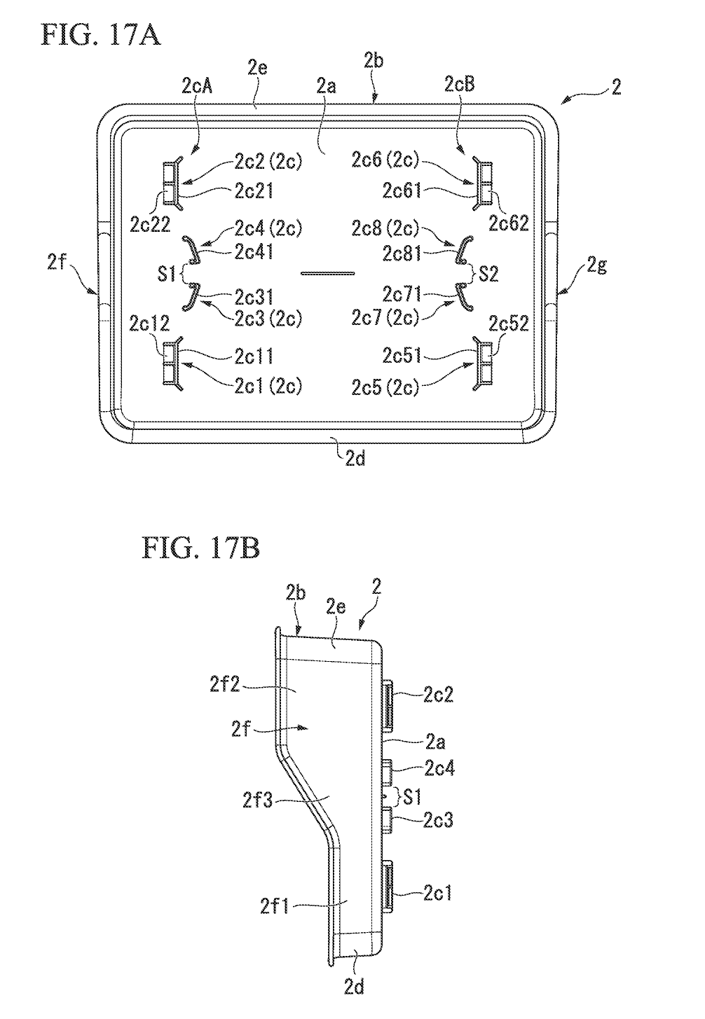

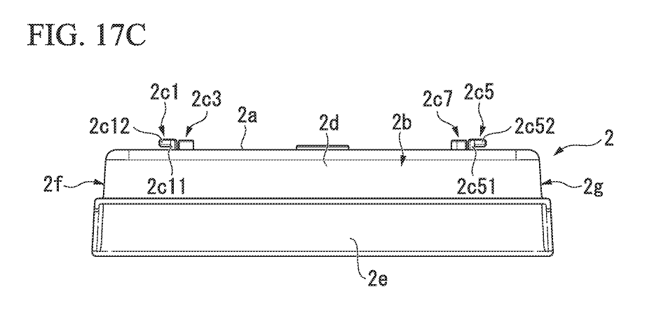

FIGS. 16A and 16B are perspective views of the main tray 2, FIG. 16A is a perspective view when the main tray 2 is viewed from above, and FIG. 16B is a perspective view when the main tray 2 is viewed from below. In addition, FIGS. 17A to 17C are a three-sided view of the main tray 2. FIG. 17A is a bottom view, FIG. 17B is a side view, and 17C is a front view. As shown in the drawings, the main tray 2 includes a bottom plate 2a, a peripheral wall portion 2b which uprightly stands on an edge portion of the bottom plate 2a, and protrusion portions 2c which are formed on the lower surface of the bottom plate 2a. In addition, in the following descriptions, for convenience of the description, a side shown in FIG. 17C is referred to as a front side and a side opposite to the front side is referred to as a rear side.

The bottom plate 2a is an article placing surface having a flat upper surface and is a plate-shaped portion which supports the placed article from below. In the present embodiment, as shown in FIGS. 16A, 16B, and 17A to 17C, the bottom plate 2a is formed in an approximately rectangular shape which is short in a depth direction and is long in a width direction.

The peripheral wall portion 2b is a wall portion which uprightly stands on the edge portion of the bottom plate 2a to surround the bottom plate 2a, and includes a front wall 2d which uprightly stands from a long side on the front side of the bottom plate 2a, a rear wall 2e which uprightly stands from a long side on the rear side of the bottom plate 2a, a first side wall 2f which uprightly stands from a left side (first side in the width direction) of the bottom plate 2a, and a second side wall 2g which uprightly stands from a right side (second side in the width direction) of the bottom plate 2a.

The vertical height of the front wall 2d is set to be lower than the vertical height of the rear wall 2e. That is, the vertical height of the rear wall 2e is set to be higher than the vertical height of the front wall 2d. Accordingly, an upper end of the front wall 2d is positioned to be lower than an upper end of the rear wall 2e. In addition, the first side wall 2f is connected to a left end of the front wall 2d and a left end of the rear wall 2e. Moreover, the second side wall 2g is connected to a right end of the front wall 2d and a right end of the rear wall 2e.

The first side wall 2f includes a front portion 2f1, a rear portion 2f2, and a first intermediate portion 2f3. The front portion 2f1 is a portion which is connected to the front wall 2d and has the same height as that of the front wall 2d. The rear portion 2f2 is a portion which is connected to the rear wall 2e and has the same height as that of the rear wall 2e. The first intermediate portion 2f3 is a portion which is disposed between the front portion 2f1 and the rear portion 212 and has an upper end which is inclined to be linearly connected to an upper end of the front portion 2f1 and an upper end of the rear portion 2f2.

The second side wall 2g includes a front portion 2g1, a rear portion 2g2, and a first intermediate portion 2g3. The front portion 2g1 is a portion which is connected to the front wall 2d and has the same height as that of the front wall 2d. The rear portion 2g2 is a portion which is connected to the rear wall 2e and has the same height as that of the rear wall 2e. The first intermediate portion 2g3 is a portion which is disposed between the front portion 2g1 and the rear portion 2g2 and has an upper end which is inclined to be linearly connected to an upper end of the front portion 2g1 and an upper end of the rear portion 2g2. In addition, as shown in FIG. 16A, the first intermediate portion 213 of the first side wall 2f and the first intermediate portion 2g3 of the second side wall 2g are provided at the same location in the depth direction.

As shown in FIG. 16A, in the main tray 2 having the peripheral wall portion 2b, the height of the peripheral wall portion 2b on the front side is low, the height of the peripheral wall portion 2b on the rear side is high, and a region surrounded by the peripheral wall portion 2b becomes an accommodation region of the article. Accordingly, the peripheral wall portion 2b is low on the front side (hereinafter, referred to as a front accommodation region Ra) of the accommodation region of the main tray 2, and thus, the article is easily put in and taken out through the front accommodation region Ra and the article placed on the front accommodation region Ra is easily viewed. Accordingly, the front accommodation region Ra becomes a region suitable for accommodating a small article. Meanwhile, the peripheral wall portion 2b is high on the rear side (hereinafter, referred to as a rear accommodation region Rb) of the accommodation region of the main tray 2, and thus, even when a tall article is inclined by traveling vibrations or the like of the cart device 1, the tall article can be supported by the peripheral wall portion 2b, and for example, the rear accommodation region Rb becomes a region suitable for accommodating a tall article stably.

In addition, the dimension of the main tray 2 in the width direction of the can device 1 is longer than the dimension of support base 3b in the width direction.

The protrusion portions 2c are portions which protrude downward from the lower surface of the bottom plate 2a. In the present embodiment, as shown in FIG. 17A, a plurality of protrusion portions 2c are formed. In addition, for convenience of description, the protrusion portions 2c are divided into a left protrusion group 2cA which is disposed on the left side of the main tray 2 and a right protrusion group 2cB which is disposed on the right side of the main tray 2.

As the protrusion portions 2c, the left protrusion group 2cA includes a front protrusion portion 2c1, a rear protrusion portion 2c2, a front center protrusion portion 2c3, and a rear center protrusion portion 2c4. As shown in FIG. 17A, the front protrusion portion 2c1, the rear protrusion portion 2c2, the front center protrusion portion 2c3, and the rear center protrusion portion 2c4 are approximately linearly arranged in the depth direction.

The front protrusion portion 2c1 includes a first hanging portion 2c11 which is hanged downward from the lower surface of the main tray 2 and an extension portion 2c12 which protrudes from the lower end of the first hanging portion 2c11 toward the right side of the main tray 2. The extension portion 2c12 is an approximately rectangular plate portion in which a long side is horizontally disposed in a depth direction of the main tray 2, a right side of the extension portion 2c12 is connected to a lower end of the first hanging portion 2c11, and thus, the extension portion 2c12 is disposed with a constant gap to the lower surface of the main tray 2. As shown in FIG. 17A, the front protrusion portion 2c1 is disposed on the foremost side of the main tray 2 among the protrusion portions of the left protrusion group 2cA.

The rear protrusion portion 2c2 is formed in the same shape as that of the front protrusion portion 2c1, and includes a first hanging portion 2c21 which is hanged downward from the lower surface of the main tray 2 and an extension portion 2c22 which protrudes toward the right side of the main tray 2 from the lower end of the first hanging portion 2c21. The extension portion 2c22 is an approximately rectangular plate portion in which a long side is horizontally disposed in the depth direction of the main tray 2, a right side of the extension portion 2c12 is connected to a lower end of the first hanging portion 2c21, and thus, the extension portion 2c22 is disposed with a constant gap to the lower surface of the main tray 2. As shown in FIG. 17A, a separation distance from the extension portion 2c22 to the lower surface of the main tray 2 is set to be the same as a separation distance from the extension portion 2c12 of the front protrusion portion 2c1 to the lower surface of the main tray 2. As shown in FIG. 17A, the rear protrusion portion 2c2 is disposed on the rearmost side of the main tray 2 among the protrusion portions of the left protrusion group 2cA.

The front center protrusion portion 2c3 and the rear center protrusion portion 2c4 are disposed between the front protrusion portion 2c1 and the rear protrusion portion 2c2. In the front center protrusion portion 2c3 and the rear center protrusion portion 2c4, the front center protrusion portion 2c3 is disposed on the front side of the main tray 2 and the rear center protrusion portion 2c4 is disposed on the rear side of the main tray 2. A fitting gap S1 is formed between the front center protrusion portion 2c3 and the rear center protrusion portion 2c4, and an engagement protrusion 4f described later included in the main tray support mechanism 4 is fitted into the fitting gap S1.

The front center protrusion portion 2c3 is disposed to be slightly displaced to the center portion side of the main tray 2 in the width direction with respect to the front protrusion portion 2c1 and the rear protrusion portion 2c2. The front center protrusion portion 2c3 has an inclined surface 2c31 which is inclined in the depth direction toward the front side of the main tray 2. The inclined surface 2c31 is a surface which faces the center side of the main tray 2 in the width direction to be continuous from the front side of the main tray 2 toward the fitting gap S1. The inclined surface 2c31 guides the engagement protrusion 4f when the front side of the main tray 2 faces the cart body 3 side and the main tray 2 is attached and detached. Similarly to the front center protrusion portion 2c3, the rear center protrusion portion 2c4 is disposed to be slightly displaced to the center portion side of the main tray 2 in the width direction with respect to the front protrusion portion 2c1 and the rear protrusion portion 2c2. The rear center protrusion portion 2c4 has an inclined surface 2c41 which is inclined in the depth direction toward the rear side of the main tray 2. The inclined surface 2c41 is a surface which faces the center side of the main tray 2 in the width direction to be continuous from the rear side of the main tray 2 toward the fitting gap S1. The inclined surface 2c31 guides the engagement protrusion 4f when the rear side of the main tray 2 faces the cart body 3 side and the main tray 2 is attached and detached. The front center protrusion portion 2c3 and the rear center protrusion portion 2c4 are symmetrical with respect to the center of the main tray 2 in the depth direction.

As the protrusion portions 2c, the right protrusion group 2cB includes a front protrusion portion 2c5, a rear protrusion portion 2c6, a front center protrusion portion 2c7, and a rear center protrusion portion 2c8. The front protrusion portion 2c5, the rear protrusion portion 2c6, the front center protrusion portion 2c7, and the rear center protrusion portion 2c8 included in the right protrusion group 2cB are laterally symmetrical to those included in the left protrusion group 2cA.

That is, the front protrusion portion 2c5 is laterally symmetrical to the front protrusion portion 2c1 of the left protrusion group 2cA and includes a first hanging portion 2c51 and an extension portion 2c52. In addition, the rear protrusion portion 2c6 is laterally symmetrical to the rear protrusion portion 2c2 of the left protrusion group 2cA and includes a first hanging portion 2c61 and an extension portion 2c62. In addition, the front center protrusion portion 2c7 is laterally symmetrical to the front center protrusion portion 2c3 of the left protrusion group 2cA and includes an inclined surface 2c71. Moreover, the rear center protrusion portion 2c8 is laterally symmetrical to the rear center protrusion portion 2c4 of the left protrusion group 2cA and includes an inclined surface 2c81. In addition, a fitting gap S2 is formed between the front center protrusion portion 2c7 and the rear center protrusion portion 2c8, and the engagement protrusion 4f described later included in the main tray support mechanism 4 is fitted into the fitting gap S2.

(Main Tray Support Mechanism)

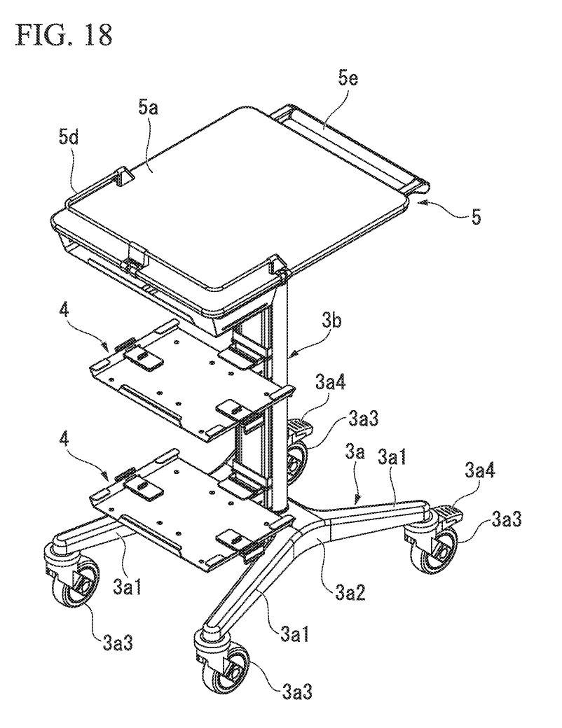

FIG. 18 is a perspective view (a perspective view in which the main trays 2 are omitted) including the cart body 3 and the main tray support mechanisms 4.

As shown FIG. 18, in the present embodiment, two main tray support mechanisms (support means, support bracket of the first article placing area) 4 are provided with respect to the cart body 3. The main tray support mechanisms 4 are disposed to be separated from each other in the vertical direction, and each thereof detachably supports the main tray 2. In addition, the main tray support mechanisms 4 have the same configuration except that the disposition heights thereof are different from each other, and thus, in the following descriptions, one main tray support mechanism 4 is described.

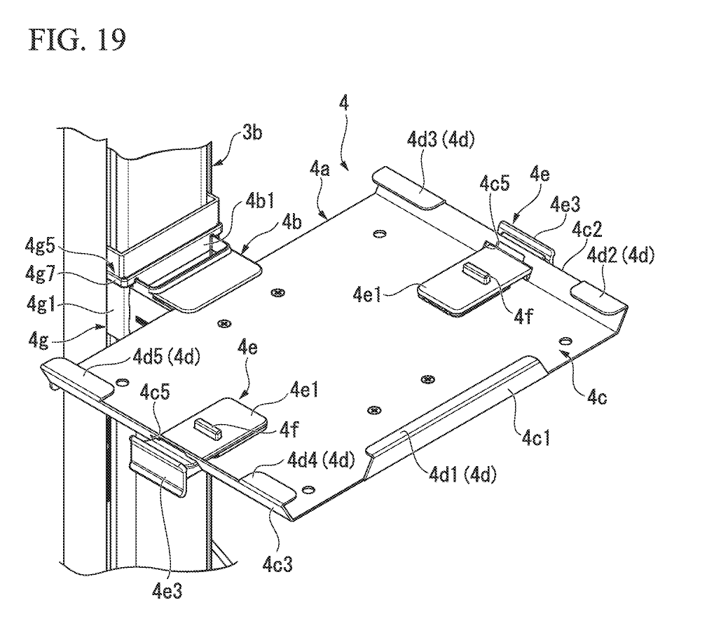

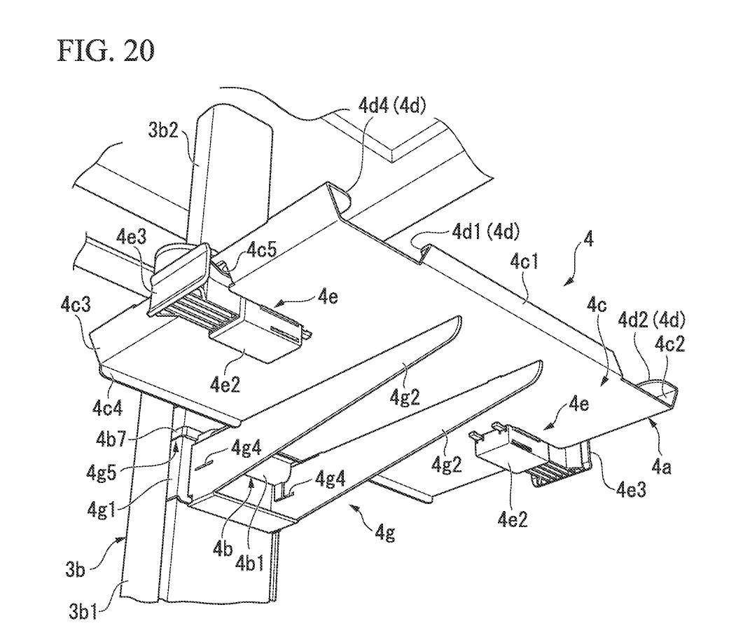

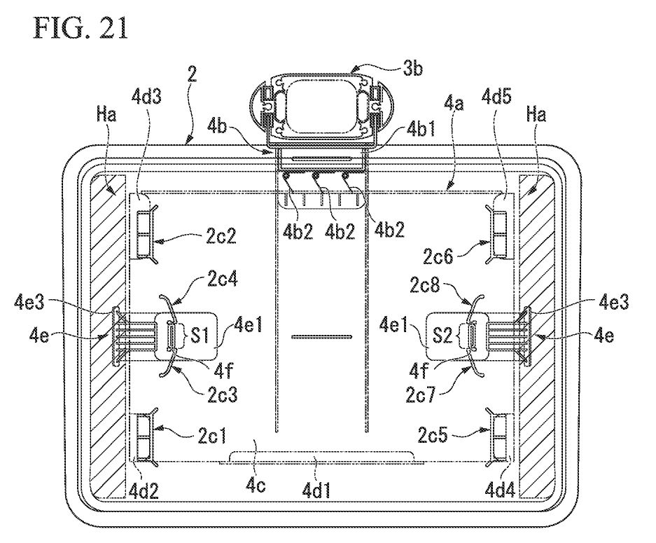

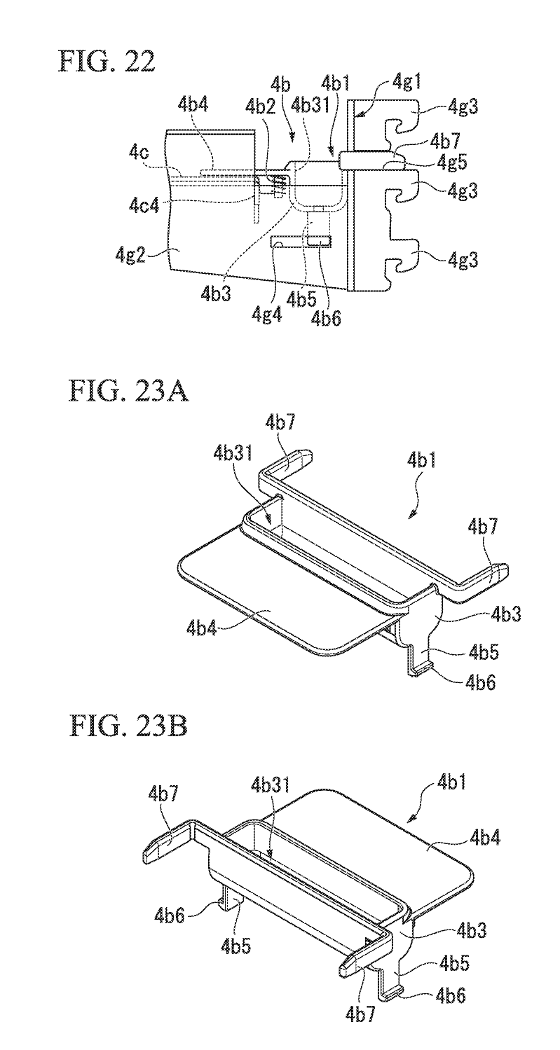

FIG. 19 is a perspective view when the main tray support mechanism 4 is viewed from above in a state where the main tray 2 is removed. In addition, FIG. 20 is a perspective view when the main tray support mechanism 4 is viewed from below in the state where the main tray 2 is removed. Moreover, FIG. 21 is a bottom view when the main tray support mechanism 4 is viewed from below in a state where the main tray 2 is attached. In addition, FIG. 22 is a side view showing a portion of the main tray support mechanism 4 on the cart body 3 side in an enlarged manner in the state where the main tray 2 is removed. As shown in the drawings, the main tray support mechanism 4 includes a support unit 4a and a lock unit 4b.

The support unit 4a includes a third base portion 4c, abutment portions 4d, tray detachment operation portions 4e, the engagement protrusions 4f, and a bracket portion 4g. The third base portion 4c is a plate-shaped portion which directly or indirectly supports the abutment portions 4d, the tray detachment operation portions 4e, and the engagement protrusions 4f. As shown in FIG. 21, the third base portion 4c is formed in an approximately rectangular shape having a smaller area than that of the lower surface of the main tray 2, and covers the lower surface of the main tray 2 such that the vicinities of both right and left ends of the lower surface of the main tray 2 are exposed. That is, in the present embodiment, both regions of the lower surface of the main tray 2 in a state where the third base portion 4c is interposed therebetween are exposed. The exposed region of the lower surface of the main tray 2 is used as a region (hereinafter, referred to as gripping regions Ha) which is gripped by a worker when the main tray 2 is detached front the main tray support mechanism 4. In this way, in the present embodiment, even in a case where the main tray 2 is mounted on the main tray support mechanism 4, a portion of the lower surface of the main tray 2 is exposed as the gripping regions Ha. The gripping regions Ha are formed to be adjacent to the tray detachment operation portions 4e, and are disposed at a position where the worker who performed the operations of the tray detachment operation portions 4e can easily grip the gripping regions Ha in the flows of the operations of the tray detachment operation portions 4e.

In addition, as shown in FIG. 19, a front edge portion 4c1, a left edge portion 4c2, and a right edge portion 4c3 of the third base portion 4c are bent upward. In addition, a rear edge portion 4c4 of the third base portion 4c is bent downward. The front edge portion 4c1, the left edge portion 4c2, and the right edge portion 4c3 of the third base portion 4c support the abutment portions 4d which are integrally connected to the edge portions 4e1, 4c2, and 4c3. Moreover, an opening 4c5 into which an operation plate 4e1 described later of the tray detachment operation portion 4e is inserted is formed at the center in the front-rear direction of each of the left edge portion 4c2 and the right edge portion 4c3. Moreover, the rear edge portion 4c4 of the third base portion 4c becomes abutment surface of each of coil springs 4b2 described later of the lock unit 4b.

The abutment portions 4d are integrally provided with the front edge portion 4c1, the left edge portion 4c2, and the right edge portion 4c3 of the third base portion 4c. In the present embodiment, as the abutment portions 4d, a front center abutment portion 4d1, a left front abutment portion 4d2, a left rear abutment portion 4d3, a right front abutment portion 4d4, and a right rear abutment portion 4d5 are provided.

The front center abutment portion 4d1 extends rearward from an upper end of the front edge portion 4c1 of the third base portion 4c, and an upper surface of the front center abutment portion 4d1 becomes an abutment surface which abuts the lower surface of the main tray 2. The left front abutment portion 4d2 is provided on a front end portion of the left edge portion 4c2 of the third base portion 4c and extends from an upper end of the left edge portion 4c2 toward the right side. An upper surface of the left front abutment portion 4d2 becomes an abutment surface which abuts the lower surface of the main tray 2, and the upper surface of the left front abutment portion 4d2 and the upper surface of the front center abutment portion 4d1 are disposed to be flush with each other. The left rear abutment portion 4d3 is provided on the rear end portion of the left edge portion 4c2 of the third base portion 4c and extends from the upper end of the left edge portion 4c2 toward the right side. An upper surface of the left rear abutment portion 4d3 becomes an abutment surface which abuts the lower surface of the main tray 2 and the upper surface of the left rear abutment portion 4d3 and the upper surface of the front center abutment portion 4d1 are disposed to be flush with each other. The right front abutment portion 4d4 is provided on the front end portion of the right edge portion 4c3 of the third base portion 4c and extends from an upper end of the right edge portion 4c3 toward the left side. An upper surface of the right front abutment portion 4d4 becomes an abutment surface which abuts the lower surface of the main tray 2, and the upper surface of the right front abutment portion 4d4 and the upper surface of the front center abutment portion 4d1 are disposed to be flush with each other. The right rear abutment portion 4d5 is provided on a rear end portion of the right edge portion 4c3 of the third base portion 4c and extends from the upper end of the right edge portion 4c3 toward the left side. An upper surface of the right rear abutment portion 4d5 becomes an abutment surface which abuts the lower surface of the main tray 2, the upper surface of the right rear abutment portion 4d5 and the upper surface of the front center abutment portion 4d1 are disposed to be flush with each other.

All the abutment portions 4d have the abutment surfaces which abut the lower surface of the main tray 2 and have the same height as each other. The main tray 2 abuts the abutment surfaces to be supported. That is, the main tray 2 is supported from below by the upper surface of the front center abutment portion 4d1, the upper surface of left front abutment portion 4d2, the upper surface of the left rear abutment portion 4d3, the upper surface of the right front abutment portion 4d4, and the upper surface of the right rear abutment portion 4d5. Accordingly, a downward movement of the main tray 2 is regulated.

In addition, the abutment portions 4d are formed to extend toward the inside of the third base portion 4c from all the upper ends of the front edge portion 4c1, the left edge portion 4c2, and the right edge portion 4c3 which are bent upward as described above. Accordingly, the abutment portions 4d are disposed to be separated from the upper surface of the third base portion 4c by a constant distance. That is, the abutment portions 4d are disposed with a constant gap in the vertical direction between the abutment portions 4d and the upper surface of the third base portion 4c.

For example, in a state where the main tray 2 is mounted on the support unit 4a, the extension portion 2c12 of the front protrusion portion 2c1 is inserted below the left front abutment portion 4d2, and the extension portion 2c22 of the rear protrusion portion 2c2 is inserted below the left rear abutment portion 4d3. In addition, the extension portion 2c52 of the front protrusion portion 2c5 is inserted below the right front abutment portion 4d4, and the extension portion 2c62 of the rear protrusion portion 2c6 is inserted below the right rear abutment portion 4d5. Accordingly, if the main tray 2 mounted on the support unit 4a tries to move upward, the extension portion 2c12 of the front protrusion portion 2c1 interferes with the left front abutment portion 4d2. Moreover, the extension portion 2c22 of the rear protrusion portion 2c2 interferes with the left rear abutment portion 4d3, the extension portion 2c52 of the front protrusion portion 2c5 interferes with the right front abutment portion 4d4, and the extension portion 2c62 of the rear protrusion portion 2c6 interferes with the right rear abutment portion 4d5.

Accordingly, an upward movement of the main tray 2 is regulated.

In addition, for example, if the main tray 2 mounted on the support unit 4a tries to move in a right-left direction of the cart device 1, the extension portion 2c12 of the front protrusion portion 2c1 and the extension portion 2c22 of the rear protrusion portion 2c2 interfere with the left edge portion 4c2 of the third base portion 4c. In addition, the extension portion 2c52 of the front protrusion portion 2c5 and the extension portion 2c62 of the rear protrusion portion 2c6 interfere with the right edge portion 4c3 of the third base portion 4c. Accordingly, a movement of the main tray 2 in the right-left direction of the cart device 1 is regulated.

The tray detachment operation portion 4e is provided on each of the right side and the left side of the third base portion 4c and is disposed at the center portion of the third base portion 4c in the front-rear direction. Each of the tray detachment operation portions 4e includes the operation plate 4e1 and an urging unit 4e2. Each of the operation plates 4e1 is a plate-shaped member which is disposed to be inserted toward the opening 4c5 which is formed in the third base portion 4c, so as to face its front and rear surfaces an upper-lower direction, and includes a gripping portion 4c3 on the end portion facing the outside of the third base portion 4c. That is, in the operation plate 4e1 of the tray detachment operation portion 4e disposed on the left side of the third base portion 4c, the gripping portion 4e3 is provided on the end portion protruding from the opening portion 4c5 toward the left side. In addition, in the operation plate 4e1 of the tray detachment operation portion 4e disposed on the right side of the third base portion 4c, the gripping portion 463 is provided on the end portion protruding from the opening portion 4c5 toward the right side.

Each of the urging units 4e2 is fixed to the lower surface of the third base portion 4c and accommodates a portion of the lower portion of the operation plate 4e1. In the urging unit 4e2, a spring (not shown) is installed inside a cover and urges the operation plate 4e toward the outside of the third base portion 4c.

In addition, the urging unit 4c2 includes a stopper (not shown) and the stopper defines a movement limit position of the operation plate 4e1 toward the outside of the third base portion 4c.

In a state where an external force except for an urging force from the urging unit 4e2 is not applied to each of the tray detachment operation portions 4e, each operation plate 4e1 is urged to the movement limit position, at which the operation plate 4e1 is regulated by the stopper (not shown), by the urging unit 4e2. Hereinafter, the movement limit position of the operation plate 4e1 is referred to as a reference position. In addition, the reference position of the operation plate 4e1 is set to a position at which the engagement protrusion 4f installed on the operation plate 4e1 is fitted to the fitting gap S1 (or fitting gap S2) of the main tray 2 in a state where the main tray 2 is mounted on the support unit 4a.

Each of the engagement protrusions 4f is formed on each operation plate 4e1. The operation plate 4e1 is a protrusion having a bar shape which is long in the front-rear direction, and a length thereof in the front-rear direction is set to be slightly shorter than a length of the fitting gap S1 and the fitting gap S2 in the depth direction of the main tray 2. The operation plate 4e1 is a reference position, and in a state where the main tray 2 is mounted on the support unit 4a, as shown in FIG. 21, each engagement protrusion 4f is fitted to the fitting gap S1 (or fitting gap S2) of the main tray 2.

For example, if the engagement protrusion 4f is fitted to the fitting gap S1 of the main tray 2, as shown in FIG. 21, the front center protrusion portion 2c3 and the rear center protrusion portion 2c4 of the main tray 2 are disposed in front of and behind the engagement protrusion 4f. As a result, when the main tray 2 moves in the front-rear direction of the cart device 1, the engagement protrusion 4f interferes with the front center protrusion portion 2c3 or the rear center protrusion portion 2c4, and the movement of the main tray 2 in the front-rear direction is regulated. In addition, if the engagement protrusion 4f is fitted to the fitting gap S2, as shown in FIG. 21, the front center protrusion portion 2c7 of the main tray 2 and the rear center protrusion portion 2c8 are disposed in front of and behind the engagement protrusion 4f. As a result, when the main tray 2 moves in the front-rear direction of the cart device 1, the engagement protrusion 4f interferes with the front center protrusion portion 2c7 or the rear center protrusion portion 2c8, the movement of the main tray 2 in the front-rear direction is regulated. Accordingly, the main tray 2 mounted on the support unit 4a cannot move in the front-rear direction of the cart device 1.

In the bracket portion 4g, as shown in FIG. 20 or 22, the bracket portion 4g includes a fifth base portion 4g1 which is fixed to the support base 3b of the cart body 3 and two arms 4g2 which extend forward from the fifth base portion 4g1. The fifth base portion 4g1 is a portion which is formed in an approximately U shape when viewed in the vertical direction, and as shown in FIG. 22, includes locking claws (locking portions) 4g3 which are formed on each of approximately U shaped-end portions. In the present embodiment, three locking claws 4g3 are vertically arranged on each of two end portions having an approximately U shape. A vertical arrangement pitch of the locking claws 4g3 is the same as a vertical arrangement pitch of the locking holes 3b6 (refer to FIG. 4, the same is applied to the following) of the shelf posts 3b4 (refer to FIG. 4, the same is applied to the following) of the cart body 3 (refer to FIG. 4, the same is applied to the following), and the locking claws 4g3 can be inserted into the locking holes 3b6. In addition, the locking claws 4g3 inserted into the locking holes 3b6 are moved downward, and thus, are locked to the shelf posts 3b4. Accordingly the bracket portion 4g (that is, the main tray support mechanism 4) is fixed to the cart body 3. In addition, by lifting the bracket portion 4g (that is, the main tray support mechanism 4) fixed to the cart body 3 with respect to the cart body 3, the locking claws 4g3 are separated from the shelf posts 3b4, and thus, the bracket portion 4g can be removed from the cart body 3.

In addition, as described above, the plurality of locking holes 3b6 are vertically formed in the shelf posts 3b4. Accordingly, in the bracket portion 4g (that is, the main tray support mechanism 4), the fifth base portion 4g1 can be fixed at an arbitrary position in the height direction of the support base 3b. That is, in the present embodiment, the main tray support mechanism 4 can be attached to arbitrary positions of the shelf posts 3b4 (attached portion) which are provided in a certain range of the support base 3b which is a portion of the cart body 3.

In addition, in the fifth base portion 4g1, a slit 4g5 is formed between the locking claw 4g3 disposed on the uppermost side in the vertical direction and the locking claw 4g3 disposed on the lowermost side among the three locking claws 4g3 arranged in the vertical direction. This slit 4g5 is a region into which a wedge portion 4b7 of a lock member 4b1 described later of the locking unit 4b is movably inserted in the front-rear direction of the cart device 1.

As shown in FIG. 20, the arms 4g2 are disposed to be separated from each other in the right-left direction of the cart device 1, and root portions of the arms 4g2 are fixed to the fifth base portion 4g1. Each of the arms 4g2 is formed in a plate shape thinned in the right-left direction of the cart device 1, and upper ends of the arms 4g2 are fixed to the lower surface of the third base portion 4c. The arms 4g2 support the fifth base portion 4g1 from below. In addition, as shown in FIG. 20, a slit 4g4 extending in the front-rear direction is formed in the vicinity of each of the roots of the arms 4g2. Claw portions 4b6 of the lock member 4b1 described later of the lock unit 4b are inserted into the slits 4g4. In addition, each of the slits 4g4 is set such that a width of the slit 4g4 in the front-rear direction of the cart device 1 is longer than that of the claw portion 4b6. Accordingly, in a state where the claw portions 4b6 are inserted into the slits 4g4, the claw portions 4b6 can move in the front-rear direction of the cart device 1.

As shown in FIG. 22, the lock unit 4b includes the lock member 4b1 and the coil springs 4b2. FIGS. 23A and 23B are perspective views of the lock member 461, FIG. 23A is a perspective view when the lock member 4b1 is viewed from the front side of the cart device 1, and FIG. 23B is a perspective view when the lock member 4b1 is viewed from the rear side of the cart device 1.

As shown in the drawings, the lock member 4b1 includes a second base portion 4b3 in which a second groove portion 4b31 to which a worker's fingers are hooked is formed, an extension plate 4b4 which extends from the second base portion 4b3 to the front side of the cart device 1, second hanging portions 4b5 which are hanged downward from the second base portion 4b3, the claw portions 4b6 which protrude to the outside from lower ends of the second hanging portions 4b5, and the wedge portions 4b7 which are provided to protrude rearward from the second base portion 4b3.

The second base portion 4b3 is formed to be long in the right-left direction and is disposed between the arms 4g2 of the bracket portion 4g (refer to FIG. 20). In addition, the second base portion 4b3 is disposed to be movable in the front-rear direction between the third base portion 4c of the support unit 4a and the fifth base portion 4g1 of the bracket portion 4g. The above-described second groove portion 4b31 is formed along the direction in which the second base portion 4b3 extends. The extension plate 4b4 is disposed to be parallel to an upper surface of the third base portion 4c above the upper surface of the third base portion 4c of the support unit 4a. The worker hooks his/her fingers to the above-described second groove portion 4b31 and pulls the lock member 4b1, and thus, the extension plate 4b4 moves along the upper surface of the third base portion 4c of the support unit 4a.

The second hanging portions 4b5 are each installed on both end portions of the second base portion 4b3 in the right-left direction. The claw portions 4b6 are inserted into the slits 4g4 formed in the arms 4g2 of the bracket portion 4g.

The claw portions 4b6 formed in the two second hanging portions 4b5 are inserted into the slits 4g4, and thus, the movements of the lock member 4b1 in the right-left direction and the vertical direction with respect to the bracket portion 4g are regulated. That is, the claw portions 4b6 are inserted into the slits 4g4, and thus, the lock member 4b1 can move in only the front-rear direction within a range of the length of the slit 4g4 in the front-rear direction.

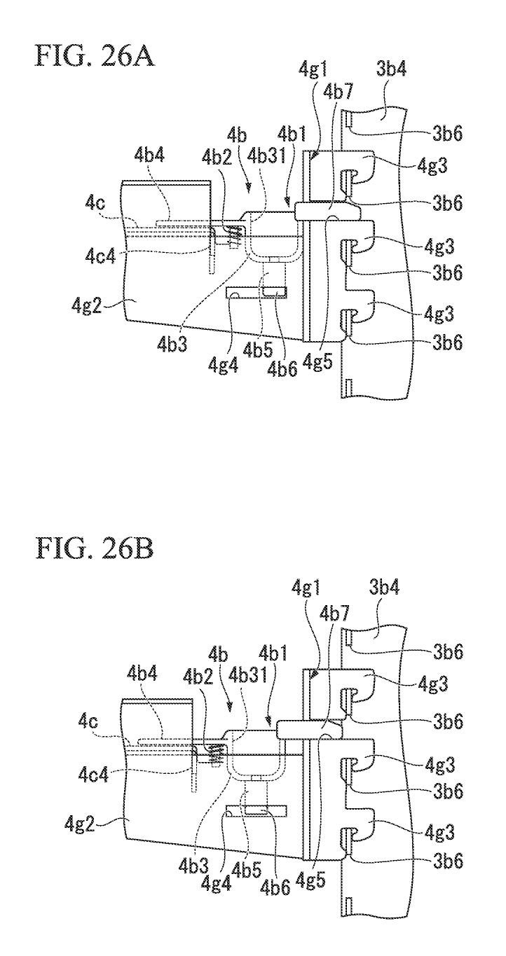

The wedge portions 4b7 are respectively installed on both end portions of the second base portion 4b3 in the right-left direction. As shown in FIG. 22, the wedge portions 4b7 are disposed in the slit 4g5 formed in the fifth base portion 4g1 of the bracket portion 4g. The lock member 4b1 is moved in the front-rear direction, and thus, the wedge portions 4b7 are moved in the front-rear direction along the slits 4g5. In addition, the length of each of the wedge portions 4b7 in the front-rear direction is set such that a tip portion of the wedge portion 4b7 is disposed between the locking claws 4g3 of the bracket portion 4g when viewed in the vertical direction in a case where the lock member 4b1 is moved most backward and the tip portion is drawn from a portion between the locking claws 4g3 of the bracket portion 4g when viewed in the vertical direction in a case where the lock member 4b1 moves most forward. In addition, the thickness of each of the wedge portions 4b7 in the vertical direction is set such that in a state where the locking claw 4g3 of the bracket portion 4g is locked to the shelf post 3b4, the wedge portion 4b7 can be inserted into a gap formed above the locking claw 4g3 and is embedded in the locking hole 3b6 together with the locking claw 4g3. If the wedge portion 4b7 can be inserted into the gap formed above the locking claw 4g3 and is embedded in the locking hole 3b6 together with the locking claw 4g3, the locking claw 4g3 cannot move upward, and thus, the support unit 4a (that is, the main tray support mechanism 4) cannot be detached from the cart body 3 (refer to FIG. 26A). That is, the main tray support mechanism 4 is locked to the cart body 3 in a state where the main tray support mechanism 4 extends forward from the support base 3b.

Each of the coil springs 4b2 is wound around a protrusion which is formed on the lower surface of the extension plate 4b4, and a tip portion of the coil spring 4b2 abuts the rear edge portion 4c4 of the third base portion 4c of the support unit 4a. As shown in FIG. 21, three coil springs 4b2 are arranged in the right-left direction. The coil springs 4b2 urge the lock member 4b1 to the rear side (the side of the support base 3b side of the cart body 3). Accordingly, in the state where an external force except for the urging forces of the coil springs 4b2 is not applied to the lock member 4b1, the lock member 4b1 is urged to the rear side (that is, the side of the support base 3b of the cart body 3). Accordingly, in a case where the worker has not moved the lock member 4b1 forward, the above-described wedge portions 4b7 can be inserted into the gap formed above the locking claws 4g3, and thus, the main tray support mechanism 4 is locked to the cart body 3.

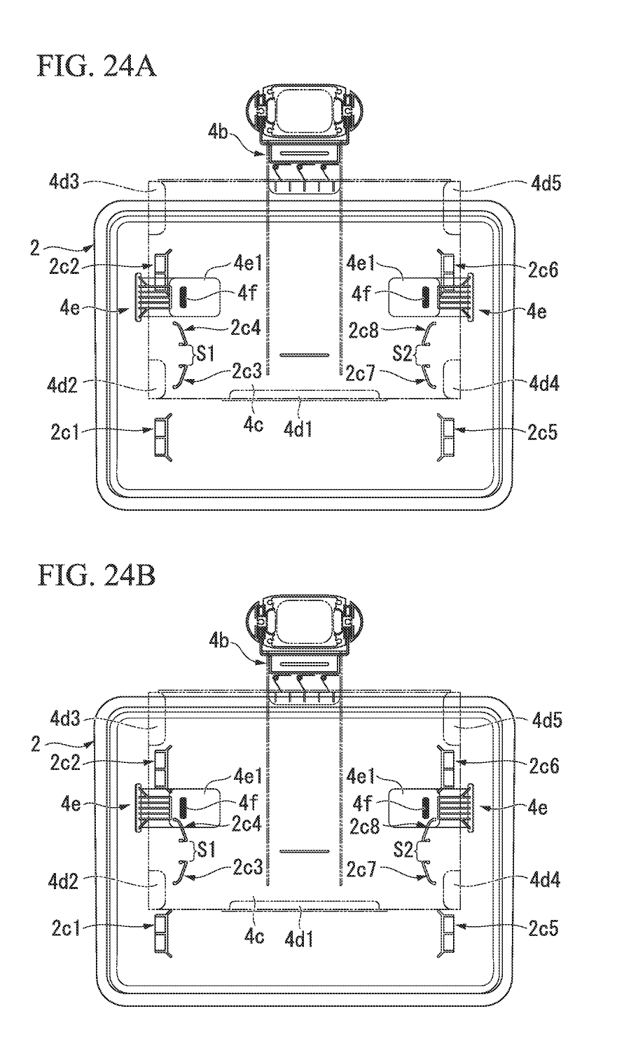

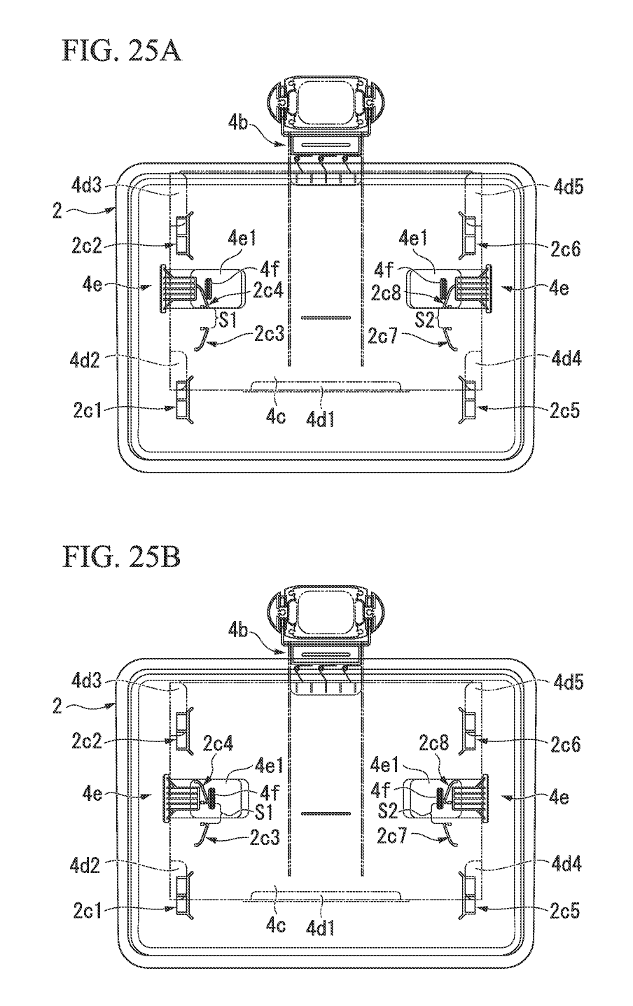

Subsequently, in the cart device 1 of the present embodiment configured as described above, an operation when the main tray 2 is mounted on the main tray support mechanism 4 will be described with reference to FIGS. 24A, 24B, 25A, and 25B.

First, as shown in FIG. 24A, the main tray 2 is disposed on the front side toward the mounting position (fixed position) of the main tray support mechanism 4. In this case, the main tray 2 is disposed such that the front protrusion portion 2c1, the rear protrusion portion 2c2, the front center protrusion portion 2c3, the rear center protrusion portion 2c4, the front protrusion portion 2c5, the rear protrusion portion 2c6, the front center protrusion portion 2c7, and the rear center protrusion portion 2c8 of the main tray 2 do not interfere with the front center abutment portion 4d1, the left front abutment portion 4d2, the left rear abutment portion 4d3, the right front abutment portion 4d4, and the right rear abutment portion 4d5 provided in the third base portion 4c of the support unit 4a.

Subsequently, as shown in FIG. 24B, the main tray 2 slides rearward. In addition, as shown in FIGS. 25A and 25B, if the engagement protrusion 4f installed on the operation plate 4e1 comes into contact with the rear center protrusion portion 2c4 included in the left protrusion group 2cA (refer to FIG. 17A) or the rear center protrusion portion 2c8 included in the right protrusion group 2cB (refer to FIG. 17A), the engagement protrusion 4f is guided along the inclined surface 2c41 (refer to FIG. 17A) of the rear center protrusion portion 2c4 or the inclined surface 2c81 (refer to FIG. 17A) of the rear center protrusion portion 2c8 to be gradually moved to the center side of the main tray support mechanism 4.

In addition, when the engagement protrusion 4f reaches the fitting gap S1 or the fitting gap S2, the engagement protrusion 4f is fitted to the fitting gap S1 or the fitting gap S2 by the urging force of the urging unit 4e2 of the tray detachment operation portion 4e (refer to FIG. 21). In this way, if the engagement protrusion 4f is fitted to the fitting gap S1 or the fitting gap S2, the front protrusion portion 2c1 of the main tray 2 and the left front abutment portion 4d2 of the support unit 4a are disposed to overlap each other in the vertical direction, the rear protrusion portion 2c2 of the main tray 2 and the left rear abutment portion 4d3 of the support unit 4a are disposed to overlap each other in the vertical direction, the front protrusion portion 2c5 of the main tray 2 and the right front abutment portion 4d4 of the support unit 4a are disposed to overlap each other in the vertical direction, and the rear protrusion portion 2c6 of the main tray 2 and the right rear abutment portion 4d5 of the support unit 4a are disposed to overlap each other in the vertical direction. As a result of the above, the main tray 2 is fixed to the main tray support mechanism 4 forward, backward, right, left, up, and down, and the mounting of the support base 3b on the main tray 2 from the front side is completed.

In addition, the dimension of the main tray 2 in the width direction is longer than the dimension of the support base 3b in the width direction. In addition, the main tray 2 is mounted on the support base 3b such that the center of the main tray 2 in the width direction coincides with the center of the support base 3b in the width direction. Accordingly, in the state where the main tray 2 is mounted on the support base 3b, the main tray 2 protrudes laterally from the support base 3b.

In addition, in a case where the main tray 2 mounted as described above is detached from the main tray support mechanism 4, the operation plate 4e1 of the tray detachment operation portion 4e is moved by pressing the gripping portion 4e3. Accordingly, the engagement protrusion 4f moves backward from the fitting gap S1 or the fitting gap S2, and thus, the main tray 2 can be moved in the front-rear direction. In this state, the worker moves the main tray 2 to the position shown in FIG. 24A and thereafter, lifts the main tray 2 in a state of gripping the main tray 2 using the gripping regions Ha shown in FIG. 21, and thus, the main tray 2 is detached from the main tray support mechanism 4. In this way, in the present embodiment, when the main tray 2 is detached from the main tray support mechanism 4, the gripping regions Ha are exposed, and thus, the main tray 2 can be easily lifted.

Moreover, here, the example in which the main tray 2 is mounted on the main tray support mechanism 4 in a state where the rear side of the main tray 2 faces the support base 3b side of the cart body 3 is described. That is, the example in which the main tray 2 disposed on the lower side in the FIG. 1 is mounted is described. However, in the cart device 1 of the present embodiment, in a state where the front side of the main tray 2 disposed on the upper side in FIG. 1 faces the support base 3b side of the cart body 3, the main tray can be mounted on the main tray support mechanism 4.

In this case, if the main tray 2 is mounted, the engagement protrusion 4f installed on the operation plate 4e1 comes into contact with the front center protrusion portion 2c3 included in the left protrusion group 2cA (refer to FIG. 17A) or the front center protrusion portion 2c7 included in the right protrusion group 2cB (refer to FIG. 17A). In addition, the engagement protrusion 4f is guided along the inclined surface 2c31 (refer to FIG. 17A) of the front center protrusion portion 2c3 or the inclined surface 2c71 (refer to FIG. 17A) of the front center protrusion portion 2c7 to be gradually moved to the center side of the main tray support mechanism 4.

Moreover, here, the example in which the main tray 2 is mounted on the front side of the support base 3b is described. However, in the cart device 1 of the present embodiment, the locking claws 4g3 are mounted on the rear locking holes 3b6 of the support base 3b, and thus, the main tray 2 can be mounted on the rear side of the support base 3b. In a case where the main tray 2 is mounted on the rear side of the support base 3b, the main tray 2 may be disposed at a height at which the main tray 2 does not interfere with the rear portions of the pocket tray 10, and the locking claws 4g3 may be locked to the locking holes 3b6 to which the locking claws 11c10 of the hanger portions 11c which support the pocket trays 10 are not locked.

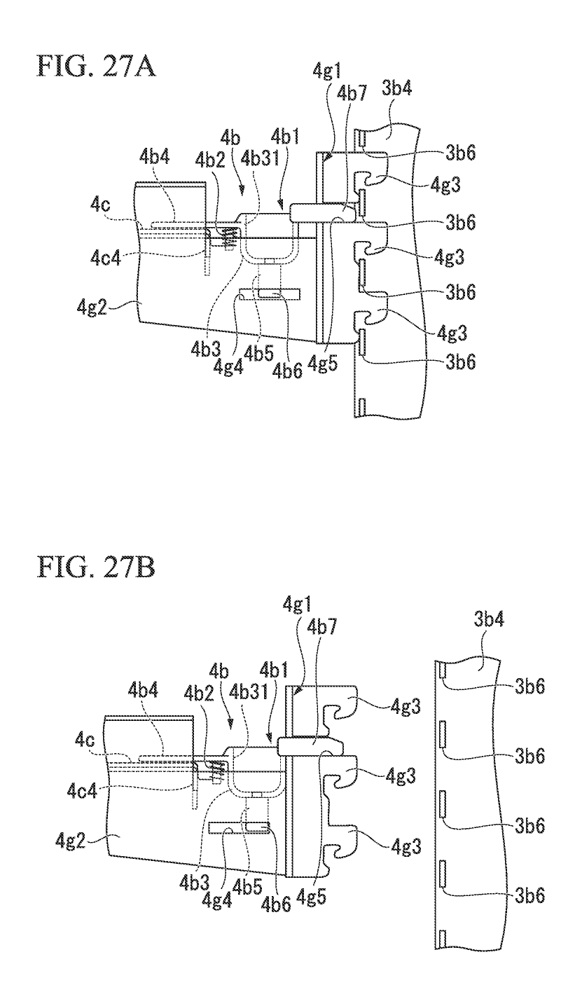

Subsequently, in the cart device 1 of the present embodiment, an operation when the main tray support mechanism 4 is detached from the cart body 3 will be described with reference to FIGS. 26A, 26B, 27A, and 27B.

As shown in FIG. 26A, in the state where the external force except for the urging forces of the coil springs 4b2 is not applied to the lock member 4b1, the lock member 4b1 is urged to the rear side (that is, the support base 3b side of the cart body 3), and thus, the wedge portions 4b7 can be inserted into the gaps formed above the locking claws 4g3. Accordingly, the main tray support mechanism 4 is locked to the cart body 3, and thus, the main tray support mechanism 4 cannot be lifted.

Accordingly, first, as shown in FIG. 26B, the lock member 4b1 is pulled to the front side. This work is performed in a state where the worker' fingers are hooked to the second groove portion 4b31. Accordingly, the wedge portions 4b7 are removed from the locking holes 3b6, and thus, it is possible to lift the main tray support mechanism 4. Thereafter, as shown in FIG. 27A, the main tray support mechanism 4 is lifted, and as shown in FIG. 27B, the main tray support mechanism 4 is extracted such that the locking claws 4g3 are removed from the locking holes 3b6, and thus, it is possible to detach the main tray support mechanism 4 from the cart body 3.

In addition, when the main tray support mechanism 4 is mounted on the cart body 3, the external force except for the urging forces of the coil springs 4b2 is not applied to the lock member 4b1, and thus, the lock member 4b1 is urged most backward. Accordingly, when the locking claws 4g3 are inserted into the locking holes 3b6, the wedge portions 4b7 interfere with the shelf posts 341. Meanwhile, by further pushing the main tray support mechanism 4, a reaction force received by the lock member 4b1 from the shelf posts 3b4 exceeds the urging forces of the coil springs 4b2, and thus, particularly, it is possible mount the main tray support mechanism 4 on the cart body 3 without operating the lock member 4b1.

In addition, in the detached main tray support mechanism 4 and main tray 2, the locking claws 4g3 are locked to the locking holes 3b6 formed at positions different from the original positions, and thus, it is possible to appropriately change the vertical positions of the main tray support mechanism 4 and the main tray 2 when the main tray 2 is mounted on the support base 3b side.

(Top Plate Unit)

As shown in FIG. 1, the top plate unit 5 includes a top plate 5a, fixed side bodies 5b, a fixed front body 5c, a fall prevention bar 5d, and the handle 5e.

The top plate 5a is an approximately rectangular plate member having an article placing surface which is an upper surface 5T on which an article such as an electronic device can be placed, and is fixed to the upper end of the inner column unit 3b2.

The fixed side bodies 5b are provided on the upper surface 5T of the top plate 5a and support the fall prevention bar 5d. The fixed side bodies 5b are provided along both sides of the top plate 5a in the width direction. In addition, the fixed side bodies 5b are provided slightly forward from the center in the front-rear direction. For example, the fixed side bodies 5b may be configured of an electrically deformable material such as a resin.

A penetrating portion 5ba which penetrates each of the fixed side bodies 5b in the width direction of the top plate 5a is formed in the fixed side body 5b. In addition, in each of the fixed side bodies 5b, a retaining wall portion 5b3 is provided, which gradually rises forward as it goes upward on the front side of the penetrating portion 5ba. Engagement of a wiring cable (not shown, the same is applied to the following) of an electronic device (not shown, the same is applied to the following) placed on the top plate 5a can be performed by the penetrating portions 5ba and the retaining wall portions 5b3.

The fixed front body 5c is provided on approximately the center of the top plate 5a in the width direction and a front end portion of the top plate 5a and supports the fall prevention bar 5d.

The fall prevention bar 5d is disposed along an edge of the top plate 5a above the front side of the top plate 5a. The fall prevention bar 5d includes a pair of fall prevention bar bodies 5d1 which is disposed between each of the fixed side bodies 5b and the fixed front body 5c. Second intermediate portions 5d2 of the fall prevention bar bodies 5d1 are bent along corner portions of the top plate 5a.

For example, this fall prevention bar 5d prevents the article such as an electronic device placed on the top plate 5a from sliding on the top plate 5a and falling from the front side of the top plate 5a when the cart device 1 stops from a traveling state thereof.

Moreover, a space surrounded by the top plate 5a, the fall prevention bar 5d, the fixed side bodies 5b, and the fixed front body 5c becomes a wire insertion space K1 into which the wire cable can be inserted. The wire cable is inserted into the wire insertion space K1 in the width direction of the top plate 5a at the end portion side of the top plate 5a in the width direction.

The handle 5e is provided to protrude backward from the rear edge portion of the top plate 5a. The handle 5e is a portion which is gripped by a worker when the cart device 1 travels.

In addition, an article accommodation portion 5f capable of accommodating an article such as an adopter (not shown) is provided on a lower surface of the top plate 5a. A hook 5f4 capable of engaging with the wire cable is provided on a lateral surface of the article accommodation portion 5f.

In the cart device 1 configured as described above, by the main tray support mechanisms 4 and the pocket tray support mechanisms 11, the main trays 2 and the pocket trays 10 in which the vertical positions thereof can be changed are disposed around the support base 3b which extends upward from the leg portion 3a capable of traveling on the floor surface.

Therefore, it is possible to change the installation position of each of the main trays 2 and the pocket trays 10 in the vertical direction according to the heights of the articles accommodated in the main trays 2 and the pocket trays 10.

In addition, the main trays 2 and the pocket trays 10 are disposed on at least three sides around the support base 3b and the articles can be placed on the three sides of the support base 3b, it is possible to secure large storage capacity.

Moreover, the locking claws 4g3 of each main tray support mechanism 4 and the locking claws 11c10 of each pocket tray support mechanism 11 are locked to the plurality of locking holes 3b6 formed in the support base 3b, and thus, the main tray support mechanism 4 and the pocket tray support mechanism 11 are attached to the support base 3b.

Accordingly, the main trays 2 and the pocket tray 10 can be mounted on the support base 3b side by a simple configuration.

Moreover, the locking claws 4g3 of the main tray support mechanisms 4 and the locking claws 11c10 of the pocket tray support mechanisms 11 can be locked to the locking holes 3b6. Accordingly, the locking holes for mounting the main trays 2 and the locking holes for mounting the pocket trays 10 are used in common, and thus, it is possible to decrease the number of the locking holes 3b6.

Moreover, the main trays 2 and the pocket trays 10 are disposed in front of the support base 3b and on both lateral sides of the support base 3b, and thus, the rear side of the support base 3b can be used as a space other than a space for placing the article. Accordingly, a space for disposing a lower limb of a user who operates the cart device can be secured on the rear side of the support base 3b.

In addition, the locking claws 4g3 of the main tray support mechanisms 4 are supported by the locking holes 3b6 formed on the front surface of the support base 3b, and the locking claws 11c10 of the pocket tray support mechanism 11 are supported by the locking holes 3b6 formed on the rear surface of the support base 3b. Accordingly even when the locking holes are not provided on the lateral surfaces of the support base 3b, the main tray 2 can be mounted in front of the support base 3b and the pocket trays 10 can be mounted on both lateral sides of the support base 3b using the locking holes 3b6 which are formed on the front surface and the rear surface of the support body 3b.

In addition, the main tray support mechanisms 4 extend forward from the locking holes 3b6 of the support base 3b and the pocket tray support mechanism 11 extend laterally from the locking holes 3b6 of the support base 3b. Accordingly, in the main trays 2 and the pocket trays 10, by causing the extension directions of the main tray support mechanisms 4 and the pocket tray support mechanism 11 to be different from each other, the locking holes can be shared.

In addition, each of the main trays 2 is formed to protrude laterally from the support base 3b, and thus, it is possible to secure a large area of the main tray 2 in a plan view. Accordingly, it is possible to secure large storage capacity of the main tray 2.

In addition, each of the pocket trays 10 is formed to protrude rearward with respect to the support base 3b, and thus, it is possible to secure a large area of the pocket tray 10 in a plan view. Therefore, it is possible to secure large storage capacity of the pocket tray 10.

In addition, the main trays 2 are disposed in front of the support base 3b and the front lateral sides thereof, and the pocket trays 10 are disposed on the lateral sides of the support base 3b and the rear lateral sides thereof. Accordingly, the article can be accommodated from the front side of the support base 3b to the lateral sides and the rear lateral sides of the support base 3b, and thus, it is possible to secure a larger storage capacity.

Hereinbefore, a preferred embodiment of the present invention is described with reference to the accompanying drawings. However, the present invention is not limited to the above embodiment. Various shapes and combinations of the constituent members shown in the above-described embodiment are merely examples, and various modifications can be made based on design requirements or the like within a scope which does not depart from the gist of the present invention.

For example, in the above-described embodiment, the main trays 2 can be disposed in front of the support base 3b and behind thereof, and the pocket trays 10 can be disposed on both lateral sides of the support base 3b. That is, the article placing members can be disposed on four sides around the support body. However, the present invention is not limited to this, and the article placing member may be disposed on at least three sides around the support body.

### INDUSTRIAL APPLICABILITY

According to the cart device according to the present invention, it is possible to cope with a height of an accommodated article and to secure large storage capacity.

### REFERENCE SIGNS LIST

1: cart device
2: main tray (first article placing area, article placing member)
3: cart body
3b6: locking hole
4: main tray support mechanism (support means, support bracket of first article placing area)
4g3, 11c10: locking claw (locking portion)
3a: leg portion (base portion)
3b: support base (support body)
10: pocket tray (second article placing area, article placing member)
11: pocket tray support mechanism (support means)
11a: bracket member (support bracket of second article placing area)

1. A cart device, comprising:
a base portion which is able to travel on a floor surface;
a support body which extends upward from the base portion;
article placing members which are disposed on at least three sides around the support body and on which an article is able to be placed; and
support means for disposing the article placing members such that a vertical position of each of the article placing members is able to be changed.

2. The cart device according to claim 1,
wherein a plurality of locking holes are formed in the support body,
wherein the support means includes
a support bracket which supports the article placing member, and
a locking portion which is provided in the support bracket and is locked to the locking holes.

3. The cart device according to claim 2,
wherein the article placing member includes
a first article placing area which is disposed in front of the support body, and
a second article placing area which is disposed on each of both lateral sides of the support body,
wherein the locking portion of the support bracket which supports the first article placing area is able to be locked to the locking holes and the locking portion of the support bracket which supports the second article placing area is able to be locked to the locking holes.

4. The cart device according to claim 3,
wherein the locking holes are formed on a front surface and a rear surface of the support body,
wherein the locking portion of the support bracket which supports the first article placing area is supported by the locking holes formed on the front surface of the support body, and
wherein the locking portion of the support bracket which supports the second article placing area is supported by the locking holes formed on the front surface of the support body or the locking holes formed on the rear surface of the support body.

5. The cart device according to claim 3,
wherein the support bracket which supports the first article placing area extends forward from the locking holes of the support body, and
wherein the support bracket which supports the second article placing area extends laterally from the locking holes of the support body.

6. The cart device according to claim 3,
wherein the first article placing area is formed to protrude laterally from the support body.

7. The cart device according to claim 3,
wherein the second article placing area is formed to protrude rearward from the support body.
